(19) United States
(12) Patent Application Publication
(10) Pub. No.: US 2014/0004328 A1
(43) Pub. Date: Jan. 2, 2014

(54) Ultralow Viscosity Liquid Crystalline Polymer Composition

(71) Applicant: TICONA LLC, Florence, KY (US)

(72) Inventors: Young Shin Kim, Erlanger, KY (US); Kamlesh P. Nair, Florence, KY (US)

(73) Assignee: TICONA LLC, Florence, KY (US)

(21) Appl. No.: 13/674,974

(22) Filed: Nov. 13, 2012

Related U.S. Application Data
(60) Provisional application No. 61/664,995, filed on Jun. 27, 2012.

(51) Int. Cl. C09K 19/54

(52) U.S. Cl. CPC C09K 19/54
USPC 428/220; 252/299.01; 252/299.5; 252/299.62

(57) ABSTRACT

A thermoplastic composition that comprises a thermotropic, liquid crystalline polymer and a combination of certain types of flow modifiers is provided. More particularly, one type of flow modifier that is employed in the composition is a functional compound (e.g., hydroxy-functional, carboxy-functional, etc.) that can react with the backbone of the polymer. In certain cases, for instance, the functional compound can initiate chain scission of the polymer, which reduces the molecular weight, and in turn, the melt viscosity of the polymer under shear. An additional non-functional compound is also employed to help reduce the melt viscosity to the desired “ultralow” levels without having a significant impact on the mechanical properties. The non-functional compound is, more specifically, an aromatic amide oligomer that can alter intermolecular polymer chain interactions without inducing chain scission to any appreciable extent, thereby further lowering the overall viscosity of the polymer matrix under shear.

### RELATED APPLICATION

The present application claims priority to U.S. provisional application Ser. No. 61/664,995, filed on Jun. 27, 2012, which is incorporated herein in its entirety by reference thereto.

### BACKGROUND OF THE INVENTION

Electrical components (e.g., fine pitch connectors) are commonly produced from wholly aromatic thermotropic liquid crystalline polymers (“LCPs”). One benefit of such polymers is that they can exhibit a relatively high “flow”, which refers to the ability of the polymer when heated under shear to uniformly fill complex parts at fast rates without excessive flashing or other detrimental processing issues. In addition to enabling complex part geometries, high polymer flow can also enhance the ultimate performance of the molded component. Most-notably, parts generated from well-flowing polymers generally display improved dimensional stability owing to the lower molded-in stress, which makes the component more amenable to downstream thermal processes that can be negatively impacted from warpage and other polymer stress relaxation processes that occur in less well-molded materials.

Despite their relatively high flow capacity, current commercial LCPs still fall short of what is needed to meet the increased molding demands of intricate part designs without significant compromises to the final product performance. In this regard, various attempts have been made to improve the flow properties of conventional polymers by lowering their melt viscosity. One approach to a lower melt viscosity has involved reducing the molecular weight of the polymer. However, decreased molecular weight polymers generally display reduced thermal and mechanical properties as well as poorer blister performance during lead-free soldering and other fabrication processes. Other approaches have also been employed that involve the addition of certain compounds to the polymer during compounding. For example, one approach employs the use of an additive that may have carboxyl and hydroxy terminal groups. Such additives, however, particularly when used in relatively high amounts, can result in the formation of volatile products due to their decomposition during melt processing and/or use. This may, in turn, lead to the formation of blisters that can adversely impact the thermal and mechanical properties of the polymer and thus limit its use in certain applications.

As such, a need exists for a liquid crystalline thermoplastic composition that has an ultralow melt viscosity, and yet still attains good mechanical properties.

### SUMMARY OF THE INVENTION

In accordance with one embodiment of the present invention, a thermoplastic composition is disclosed that comprises a thermotropic liquid crystalline polymer, an aromatic amide oligomer, and a functional compound that includes hydroxyl groups, carboxyl groups, amine groups, or a combination thereof. The thermoplastic composition has a melt viscosity of from about 0.1 to about 80 Pa-s, as determined at a shear rate of 1000 seconds-1 and temperature of 350° C. in accordance with ASTM Test No. 1238-70.

Other features and aspects of the present invention are set forth in greater detail below.

### BRIEF DESCRIPTION OF THE FIGURES

A full and enabling disclosure of the present invention, including the best mode thereof to one skilled in the art, is set forth more particularly in the remainder of the specification, including reference to the accompanying figures, in which:

FIG. 1 is an exploded perspective view of one embodiment of a fine pitch electrical connector that may be formed according to the present invention;

FIG. 2 is a front view of opposing walls of the fine pitch electrical connector of FIG. 1;

FIG. 3 is a schematic illustration of one embodiment of an extruder screw that may be used to form the thermoplastic composition of the present invention;

FIGS. 4-5 are respective front and rear perspective views of an electronic component that can employ an antenna structure formed in accordance with one embodiment of the present invention; and

FIGS. 6-7 are perspective and front views of a compact camera module (“CCM”) that may be formed in accordance with one embodiment of the present invention.

### DETAILED DESCRIPTION

It is to be understood by one of ordinary skill in the art that the present discussion is a description of exemplary embodiments only, and is not intended as limiting the broader aspects of the present invention.

Generally speaking, the present invention is directed to a thermoplastic composition that comprises a thermotropic liquid crystalline polymer and a combination of certain types of flow modifiers. More particularly, one type of flow modifier that is employed in the composition is a functional compound (e.g., hydroxy-functional, carboxy-functional, etc.) that can react with the backbone of the polymer. In certain cases, for instance, the functional compound can initiate chain scission of the polymer, which reduces the molecular weight, and in turn, the melt viscosity of the polymer under shear. While effective, the ability of such a compound to reduce melt viscosity is generally correlated to a reduction in polymer molecular weight. Because too great of a reduction in molecular weight can adversely impact mechanical properties, however, the melt viscosity levels that can be attained with the functional compound is practically restricted. In this regard, the present inventors have discovered that an additional non-functional compound can also be employed as a flow modifier to help reduce the melt viscosity to the desired “ultralow” levels without having a significant impact on the mechanical properties. The non-functional compound is, more specifically, an aromatic amide oligomer that can alter intermolecular polymer chain interactions without inducing chain scission to any appreciable extent, thereby further lowering the overall viscosity of the polymer matrix under shear. Surprisingly, such low melt viscosities can be achieved using this unique combination flow modifiers without adversely impacting process stability, such as screw recovery time and filling pressure during molding process.

As a result of this discovery, the present inventors have found that thermoplastic compositions may be formed with ultralow melt viscosity values, such as in the range of from about 0.1 to about 80 Pa-s, in some embodiments from about 0.5 to about 50 Pa-s, and in some embodiments, from about 1 to about 25 Pa-s, determined at a shear rate of 1000 seconds⁻¹. Melt viscosity may be determined in accordance with ASTM Test No. 1238-70 at a temperature of 350° C. Among other things, such an ultralow viscosity can allow the composition to readily flow into the cavity of a mold having small dimensions. Conventionally, it was believed that thermoplastic compositions having such an ultralow viscosity could not also possess sufficiently good thermal and mechanical properties to enable their use in certain types of applications. Contrary to conventional thought, however, the thermoplastic composition of the present invention has been found to possess both excellent thermal and mechanical properties. For example, the composition may possess a high impact strength, which is useful when forming small parts. The composition may, for instance, possess a Charpy notched impact strength greater than about 4 kJ/m², in some embodiments from about 5 to about 40 kJ/m², and in some embodiments, from about 6 to about 30 kJ/m², measured at 23° C. according to ISO Test No. 179-1) (technically equivalent to ASTM D256, Method B).

The tensile and flexural mechanical properties of the composition are also good. For example, the thermoplastic composition may exhibit a tensile strength of from about 20 to about 500 MPa, in some embodiments from about 50 to about 400 MPa, and in some embodiments, from about 100 to about 350 MPa; a tensile break strain of about 0.5% or more, in some embodiments from about 0.6% to about 10%, and in some embodiments, from about 0.8% to about 3.5%; and/or a tensile modulus of from about 5,000 MPa to about 20,000 MPa, in some embodiments from about 8,000 MPa to about 20,000 MPa, and in some embodiments, from about 10,000 MPa to about 15,000 MPa. The tensile properties may be determined in accordance with ISO Test No. 527 (technically equivalent to ASTM D638) at 23° C. The thermoplastic composition may also exhibit a flexural strength of from about 20 to about 500 MPa, in some embodiments from about 50 to about 400 MPa, and in some embodiments, from about 100 to about 350 MPa; a flexural break strain of about 0.5% or more, in some embodiments from about 0.6% to about 10%, and in some embodiments, from about 0.8% to about 3.5%; and/or a flexural modulus of from about 5,000 MPa to about 20,000 MPa, in some embodiments from about 8,000 MPa to about 20,000 MPa, and in some embodiments, from about 10,000 MPa to about 15,000 MPa. The flexural properties may be determined in accordance with ISO Test No. 178 (technically equivalent to ASTM D790) at 23° C.

The melting temperature of the composition may likewise be from about 250° C. to about 400° C., in some embodiments from about 270° C. to about 380° C., and in some embodiments, from about 300° C. to about 360° C. The melting temperature may be determined as is well known in the art using differential scanning calorimetry (“DSC”), such as determined by ISO Test No. 11357. Even at such melting temperatures, the ratio of the deflection temperature under load (“DTUL”), a measure of short term heat resistance, to the melting temperature may still remain relatively high. For example, the ratio may range from about 0.65 to about 1.00, in some embodiments from about 0.66 to about 0.95, and in some embodiments, from about 0.67 to about 0.85. The specific DTUL values may, for instance, range from about 200° C. to about 300° C., in some embodiments from about 210° C. to about 280° C., and in some embodiments, from about 220° C. to about 260° C. Such high DTUL values can, among other things, allow the use of high speed processes often employed during the manufacture of components having a small dimensional tolerance.

Various embodiments of the present invention will now be described in more detail.

### I. Liquid Crystalline Polymer

The thermotropic liquid crystalline polymer generally has a high degree of crystallinity that enables it to effectively fill the small spaces of a mold. The amount of such liquid crystalline polymers is typically from about 20 wt. % to about 90 wt. %, in some embodiments from about 30 wt. % to about 80 wt. %, and in some embodiments, from about 40 wt. % to about 75 wt. % of the thermoplastic composition. Suitable thermotropic liquid crystalline polymers may include aromatic polyesters, aromatic poly(esteramides), aromatic poly(estercarbonates), aromatic polyamides, etc., and may likewise contain repeating units formed from one or more aromatic hydroxycarboxylic acids, aromatic dicarboxylic acids, aromatic diols, aromatic aminocarboxylic acids, aromatic amines, aromatic diamines, etc., as well as combinations thereof.

Aromatic polyesters, for instance, may be obtained by polymerizing (1) two or more aromatic hydroxycarboxylic acids; (2) at least one aromatic hydroxycarboxylic acid, at least one aromatic dicarboxylic acid, and at least one aromatic diol; and/or (3) at least one aromatic dicarboxylic acid and at least one aromatic diol. Examples of suitable aromatic hydroxycarboxylic acids include, 4-hydroxybenzoic acid; 4-hydroxy-4′-biphenylcarboxylic acid; 2-hydroxy-6-naphthoic acid; 2-hydroxy-5-naphthoic acid; 3-hydroxy-2-naphthoic acid; 2-hydroxy-3-naphthoic acid; 4′-hydroxyphenyl-4-benzoic acid; 3′-hydroxyphenyl-4-benzoic acid; 4′-hydroxyphenyl-3-benzoic acid, etc., as well as alkyl, alkoxy, aryl and halogen substituents thereof. Examples of suitable aromatic dicarboxylic acids include terephthalic acid; isophthalic acid; 2,6-naphthalenedicarboxylic acid; diphenyl ether-4,4′-dicarboxylic acid; 1,6-naphthalenedicarboxylic acid; 2,7-naphthalenedicarboxylic acid; 4,4′-d icarboxybiphenyl; bis(4-carboxyphenyl)ether; bis(4-carboxyphenyl)butane; bis(4-carboxyphenyl)ethane; bis(3-carboxyphenyl)ether; bis(3-carboxyphenyl)ethane, etc., as well as alkyl, alkoxy, aryl and halogen substituents thereof. Examples of suitable aromatic diols include hydroquinone; resorcinol; 2,6-dihydroxynaphthalene; 2,7-dihydroxynaphthalene; 1,6-dihydroxynaphthalene; 4,4′-dihydroxybiphenyl; 3,3′-dihydroxybiphenyl; 3,4′-dihydroxybiphenyl; 4,4′-dihydroxybiphenyl ether; bis(4-hydroxyphenyl)ethane, etc., as well as alkyl, alkoxy, aryl and halogen substituents thereof. The synthesis and structure of these and other aromatic polyesters may be described in more detail in U.S. Pat. Nos. 4,161,470; 4,473,682; 4,522,974; 4,375,530; 4,318,841; 4,256,624; 4,219,461; 4,083,829; 4,184,996; 4,279,803; 4,337,190; 4,355,134; 4,429,105; 4,393,191; 4,421,908; 4,434,262; and 5,541,240.

Liquid crystalline polyesteramides may likewise be obtained by polymerizing (1) at least one aromatic hydroxycarboxylic acid and at least one aromatic aminocarboxylic acid; (2) at least one aromatic hydroxycarboxylic acid, at least one aromatic dicarboxylic acid, and at least one aromatic amine and/or diamine optionally having phenolic hydroxy groups; and (3) at least one aromatic dicarboxylic acid and at least one aromatic amine and/or diamine optionally having phenolic hydroxy groups. Suitable aromatic amines and diamines may include, for instance, 3-aminophenol; 4-aminophenol; 1,4-phenylenediamine; 1,3-phenylenediamine, etc., as well as alkyl, alkoxy, aryl and halogen substituents thereof. In one particular embodiment, the aromatic polyesteramide contains monomer units derived from 2,6-hydroxynaphthoic acid, terephthalic acid, and 4-aminophenol. In another embodiment, the aromatic polyesteramide contains monomer units derived from 2,6-hydroxynaphthoic acid, and 4-hydroxybenzoic acid, and 4-aminophenol, as well as other optional monomers (e.g., 4,4′-dihydroxybiphenyl and/or terephthalic acid). The synthesis and structure of these and other aromatic poly(esteramides) may be described in more detail in U.S. Pat. Nos. 4,339,375; 4,355,132; 4,351,917; 4,330,457; 4,351,918; and 5,204,443.

If desired, the liquid crystalline polymer may be a “low naphthenic” polymer to the extent that it contains a minimal content of repeating units derived from naphthenic hydroxycarboxylic acids and naphthenic dicarboxylic acids, such as naphthalene-2,6-dicarboxylic acid (“NDA”), 6-hydroxy-2-naphthoic acid (“HNA”), or combinations thereof. That is, the total amount of repeating units derived from naphthenic hydroxycarboxylic and/or dicarboxylic acids (e.g., NDA, HNA, or a combination of HNA and NDA) may be no more than about 10 mol. %, in some embodiments no more than about 8 mol. %, and in some embodiments, from 0 mol. % to about 5 mol. % of the polymer (e.g., 0 mol. %). Despite the absence of a high level of conventional naphthenic acids, it is believed that the resulting “low naphthenic” polymers are still capable of exhibiting good thermal and mechanical properties, as described above.

In one particular embodiment, for example, a “low naphthenic” aromatic polyester may be formed that contains monomer repeat units derived from 4-hydroxybenzoic acid and terephthalic acid (“TA”) and/or isophthalic acid (“IA”). The monomer units derived from 4-hydroxybenzoic acid (“HBA”) may constitute from about 40 mol. % to about 95 mol. %, in some embodiments from about 45 mol. % to about 90 mol. %, and in some embodiments, from about 50 mol. % to about 80 mol. % of the polymer, while the monomer units derived from terephthalic acid and/or isophthalic acid may each constitute from about 1 mol. % to about 30 mol. %, in some embodiments from about 2 mol. % to about 25 mol. %, and in some embodiments, from about 3 mol. % to about 20 mol. % of the polymer. Other monomeric units may optionally be employed, such as aromatic diols (e.g., 4,4′-biphenol, hydroquinone, etc.). For example, hydroquinone (“HQ”), 4,4′-biphenol (“BP”), and/or acetaminophen (“APAP”) may each constitute from about 1 mol. % to about 30 mol. %, in some embodiments from about 2 mol. % to about 25 mol. %, and in some embodiments, from about 3 mol. % to about 20 mmol. % when employed. If desired, the polymer may also contain a small amount of 6-hydroxy-2-naphthoic acid (“HNA”) within the ranges noted above.

The liquid crystalline polymers may be prepared by introducing the appropriate monomer(s) (e.g., aromatic hydroxycarboxylic acid, aromatic dicarboxylic acid, aromatic diol, aromatic amine, aromatic diamine, etc.) into a reactor vessel to initiate a polycondensation reaction. The particular conditions and steps employed in such reactions are well known, and may be described in more detail in U.S. Pat. No. 4,161,470 to Calundann; U.S. Pat. No. 5,616,680 to Linstid, III, et al.; U.S. Pat. No. 6,114,492 to Linstid, III, et al.; U.S. Pat. No. 6,514,611 to Shepherd, et al.; and WO 2004/058851 to Wamoner. The vessel employed for the reaction is not especially limited, although it is typically desired to employ one that is commonly used in reactions of high viscosity fluids. Examples of such a reaction vessel may include a stirring tank-type apparatus that has an agitator with a variably-shaped stirring blade, such as an anchor type, multistage type, spiral-ribbon type, screw shaft type, etc., or a modified shape thereof. Further examples of such a reaction vessel may include a mixing apparatus commonly used in resin kneading, such as a kneader, a roll mill, a Banbury mixer, etc.

If desired, the reaction may proceed through the acetylation of the monomers as referenced above and known the art. This may be accomplished by adding an acetylating agent (e.g., acetic anhydride) to the monomers. Acetylation is generally initiated at temperatures of about 90° C. During the initial stage of the acetylation, reflux may be employed to maintain vapor phase temperature below the point at which acetic acid byproduct and anhydride begin to distill. Temperatures during acetylation typically range from between 90° C. to 150° C., and in some embodiments, from about 110° C. to about 150° C. If reflux is used, the vapor phase temperature typically exceeds the boiling point of acetic acid, but remains low enough to retain residual acetic anhydride. For example, acetic anhydride vaporizes at temperatures of about 140° C. Thus, providing the reactor with a vapor phase reflux at a temperature of from about 110° C. to about 130° C. is particularly desirable. To ensure substantially complete reaction, an excess amount of acetic anhydride may be employed. The amount of excess anhydride will vary depending upon the particular acetylation conditions employed, including the presence or absence of reflux. The use of an excess of from about 1 to about 10 mole percent of acetic anhydride, based on the total moles of reactant hydroxyl groups present is not uncommon.

Acetylation may occur in a separate reactor vessel, or it may occur in situ within the polymerization reactor vessel. When separate reactor vessels are employed, one or more of the monomers may be introduced to the acetylation reactor and subsequently transferred to the polymerization reactor. Likewise, one or more of the monomers may also be directly introduced to the reactor vessel without undergoing pre-acetylation.

In addition to the monomers and optional acetylating agents, other components may also be included within the reaction mixture to help facilitate polymerization. For instance, a catalyst may be optionally employed, such as metal salt catalysts (e.g., magnesium acetate, tin(I) acetate, tetrabutyl titanate, lead acetate, sodium acetate, potassium acetate, etc.) and organic compound catalysts (e.g., N-methylimidazole). Such catalysts are typically used in amounts of from about 50 to about 500 parts per million based on the total weight of the recurring unit precursors. When separate reactors are employed, it is typically desired to apply the catalyst to the acetylation reactor rather than the polymerization reactor, although this is by no means a requirement.

The reaction mixture is generally heated to an elevated temperature within the polymerization reactor vessel to initiate melt polycondensation of the reactants. Polycondensation may occur, for instance, within a temperature range of from about 210° C. to about 400° C., and in some embodiments, from about 250° C. to about 350° C. For instance, one suitable technique for forming an aromatic polyester may include charging precursor monomers (e.g., 4-hydroxybenzoic acid and 2,6-hydroxynaphthoic acid) and acetic anhydride into the reactor, heating the mixture to a temperature of from about 90° C. to about 150° C. to acetyllze a hydroxyl group of the monomers (e.g., forming acetoxy), and then increasing the temperature to a temperature of from about 210° C. to about 400° C. to carry out melt polycondensation. As the final polymerization temperatures are approached, volatile byproducts of the reaction (e.g., acetic acid) may also be removed so that the desired molecular weight may be readily achieved. The reaction mixture is generally subjected to agitation during polymerization to ensure good heat and mass transfer, and in turn, good material homogeneity. The rotational velocity of the agitator may vary during the course of the reaction, but typically ranges from about 10 to about 100 revolutions per minute (“rpm”), and in some embodiments, from about 20 to about 80 rpm. To build molecular weight in the melt, the polymerization reaction may also be conducted under vacuum, the application of which facilitates the removal of volatiles formed during the final stages of polycondensation. The vacuum may be created by the application of a suctional pressure, such as within the range of from about 5 to about 30 pounds per square inch (“psi”), and in some embodiments, from about 10 to about 20 psi.

Following melt polymerization, the molten polymer may be discharged from the reactor, typically through an extrusion orifice fitted with a die of desired configuration, cooled, and collected. Commonly, the melt is discharged through a perforated die to form strands that are taken up in a water bath, pelletized and dried. The resin may also be in the form of a strand, granule, or powder. While unnecessary, it should also be understood that a subsequent solid phase polymerization may be conducted to further increase molecular weight. When carrying out solid-phase polymerization on a polymer obtained by melt polymerization, it is typically desired to select a method in which the polymer obtained by melt polymerization is solidified and then pulverized to form a powdery or flake-like polymer, followed by performing solid polymerization method, such as a heat treatment in a temperature range of 200° C. to 350° C. under an inert atmosphere (e.g., nitrogen).

Regardless of the particular method employed, the resulting liquid crystalline polymer typically has a high number average molecular weight (Mᵣ) of about 2,000 grams per mole or more, in some embodiments from about 4,000 grams per mole or more, and in some embodiments, from about 5,000 to about 30,000 grams per mole. Of course, it is also possible to form polymers having a lower molecular weight, such as less than about 2,000 grams per mole, using the method of the present invention. The intrinsic viscosity of the polymer, which is generally proportional to molecular weight, may also be relatively high. For example, the intrinsic viscosity may be about 4 deciliters per gram (“dL/g”) or more, in some embodiments about 5 dL/g or more, in some embodiments from about 6 to about 20 dig, and in some embodiments from about 7 to about 15 dL/g. Intrinsic viscosity may be determined in accordance with ISO-1628-5 using a 50/50 (v/v) mixture of pentafluorophenol and hexafluoroisopropanol.

### II. Flow Modifiers

A. Functional Compound

The functional compounds used herein may be mono-, di-, trifunctional, etc. Suitable functional groups may include, for instance, hydroxyl, carboxyl, amine (e.g., primary or secondary), etc., as well as combinations thereof. In one particular embodiment, for example, a hydroxy-functional compound is employed in the thermoplastic composition of the present invention. The term “hydroxy-functional” generally means that the compound contains at least one hydroxyl functional group or is capable of possessing such a functional group in the presence of a solvent. Without intending to be limited by theory, it is believed that the hydroxyl group of the compound can attack the electron deficient carbonyl carbon atoms of the thermotropic liquid crystalline polymer (e.g., polyester or polyesteramide) to initiate chain scission of the polymer. This reduces the molecular weight, and in turn, the melt viscosity of the polymer under shear.

The total molecular weight of the hydroxy-functional compound is relatively low so that it so that it can effectively serve as a flow aid for the polymer composition. The compound typically has a molecular weight of from about 2,000 grams per mole or less, in some embodiments from about 25 to about 1,000 grams per mole, in some embodiments from about 50 to about 500 grams per mole, and in some embodiments, from about 100 to about 400 grams per mole. The hydroxy-functional compound may also contain a core formed from one or more aromatic rings (including heteroaromatic) similar in nature to the aromatic constituents of the liquid crystalline polymer. Such an aromatic compound may have the general structure provided below in Formula (I):

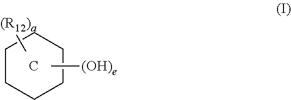

or a metal salt thereof, wherein,

ring C is a 6-membered aromatic ring wherein 1 to 3 ring carbon atoms are optionally replaced by nitrogen or oxygen, wherein each nitrogen is optionally oxidized, and wherein ring C may be optionally fused or linked to a 5- or 6-membered aryl, heteroaryl, cycloalkyl, or heterocyclyl;

R₁₂ is acyl, acyloxy (e.g., acetyloxy), acylamino (e.g., acetylamino), alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy;

a is from 0 to 4, in some embodiments from 0 to 2, and in some embodiments, from 0 to 1; and

e is from 1 to 3, and in some embodiments, from 1 to 2. When the compound is in the form of a metal salt, suitable metal counterions may include transition metal counterions (e.g., copper, iron, etc.), alkali metal counterions (e.g., potassium, sodium, etc.), alkaline earth metal counterions (e.g., calcium, magnesium, etc.), and/or main group metal counterions (e.g., aluminum).

In one embodiment, for example, e is 1 and C is phenyl in Formula (I) such that the hydroxy-functional compound is a phenol having the following formula (II):

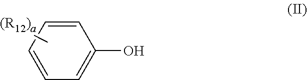

or a metal salt thereof, wherein,

R₁₂ is acyl, acyloxy, acylamino, alkoxy, alkenyl, alkyl, amino, carboxyl, carboxyl ester, hydroxyl, halo, or haloalkyl; and

a is from 0 to 4, in some embodiments from 0 to 2, and in some embodiments, from 0 to 1. Particular examples of such hydroxy-functional phenolic compounds include, for instance, phenol (a is 0); sodium phenoxide (a is 0); hydroquinone (R₁₂ is OH and a is 1); resorcinol (R₁₂ is OH and a is 1); 4-hydroxybenzoic acid (R₁₂ is C(O)OH and a is 1); etc.

In another embodiment, C is phenyl, a is 1, and R₁₂ is phenyl in Formula (I) above such that the hydroxy-functional compound is a biphenyl having the following formula (III):

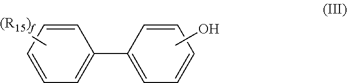

or a metal salt thereof, wherein,

R₁₅ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and

f is from 0 to 4, in some embodiments from 0 to 2, and in some embodiments, from 0 to 1. Particular examples of such biphenyl compounds include, for instance, 4,4′-biphenol (R₁₅ is OH and f is 1); 3,3′-biphenol (R₁₅ is OH and f is 1); 3,4′-biphenol (R₁₅ is OH and f is 1); 4-phenylphenol (f is 0); sodium 4-phenylphenoxide (f is 0); bis(4-hydroxyphenyl)ethane (R₁₅ is C₂(OH)₂-phenol and f is 1); tris(4-hydroxyphenyl)ethane (R₁₅ is C(CH₃)biphenol and f is 1); 4-hydroxy-4′-biphenylcarboxylic acid (R₁₅ is C(O)OH and f is 1); 4′-hydroxyphenyl-4-benzoic acid (R₁₅ is C(O)OH and f is 1); 3′-hydroxyphenyl-4-benzoic acid (R₁₅ is C(O)OH and f is 1); 4′-hydroxyphenyl-3-benzoic acid (R₁₅ is C(O)OH and f is 1); etc.

In yet another embodiment, C is naphthenyl in Formula (I) above such that the hydroxy-functional compound is a naphthol having the following formula (IV):

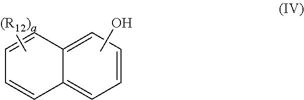

or a metal salt thereof, wherein,

R₁₂ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and

a is from 0 to 4, in some embodiments from 0 to 2, and in some embodiments, from 0 to 1. Particular examples of such naphthol compounds include, for instance, 2-hydroxy-naphthelene (a is 0); sodium 2-naphthoxide (q is 0); 2-hydroxy-6-naphthoic acid (R₁₂ is C(O)OH and a is 1); 2-hydroxy-5-naphthoic acid (R₁₂ is C(O)OH and a is 1); 3-hydroxy-2-naphthoic acid (R₁₂ is C(O)OH and a is 1); 2-hydroxy-3-naphthoic acid (R₁₂ is C(O)OH and a is 1); 2,6-dihydroxynaphthalene (R₁₂ is OH and a is 1); 2,7-dihydroxynaphthalene (R₁₂ is OH and a is 1); 1,6-dihydroxynaphthalene (R₁₂ is OH and a is 1); etc.

Other classes of hydroxy-functional compounds may also be employed in the present invention, either alone or in combination with those discussed above. For example, in certain embodiments, water is also a suitable hydroxy-functional compound, and can be used alone or in combination with other hydroxy-functional compounds. A compound can also be added in a form that generates water under the process conditions. For example, a hydroxide can be employed that under the process conditions (e.g., high temperature) effectively “loses” water. One example of such a compound is a metal hydroxide compound having the general formula M(OH)ₛ, where s is the oxidation state (typically from 1 to 3) and M is a metal, such as a transitional metal, alkali metal, alkaline earth metal, or main group metal. Examples of suitable metal hydroxides may include copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), and so forth. Also suitable are metal alkoxide compounds that are capable of forming a hydroxyl functional group in the presence of a solvent, such as water. Such compounds may have the general formula M(OR)ₛ, wherein s is the oxidation state (typically from 1 to 3), M is a metal, and R is alkyl. Examples of such metal alkoxides may include copper (II) ethoxide (Cu²⁺(CH₃CH₂O⁻)₂), potassium ethoxide (K⁺(CH₃CH₂O⁻)), sodium ethoxide (Na⁺(CH₃CH₂O⁻)), magnesium ethoxide (Mg²⁺(CH₃CH₂O⁻)₂), calcium ethoxide (Ca²⁺(CH₃CH₂O⁻)₂), etc.; aluminum ethoxide (Al³⁺(CH₃CH₂O⁻)₃), and so forth.

When employed, hydroxy-functional compounds typically constitute from about 0.05 wt. % to about 4 wt. %, in some embodiments from about 0.1 wt. % to about 2 wt. %, and in some embodiments, from about 0.2 wt. % to about 1 wt. % of the thermoplastic composition. In certain embodiments, the thermoplastic composition employs a combination of different hydroxy-functional compounds. For example, a biphenyl hydroxy-functional compound (e.g., 4,4′-biphenol) may be employed in combination with a metal hydroxide (e.g., aluminum hydroxide). In fact, the present inventors have discovered that this specific combination of hydroxy-functional compounds can help reduce melt viscosity and improve flow without having an adverse impact on mechanical properties. Typically, the weight ratio of metal hydroxides to biphenyl hydroxy-functional compounds is from about 0.5 to about 8, in some embodiments from about 0.8 to about 5, and in some embodiments, from about 1 to about 5. For instance, biphenyl compounds may constitute from about 0.01 wt. % to about 1 wt. %, and in some embodiments, from about 0.05 wt. % to about 0.4 wt. % of the thermoplastic composition, while metal hydroxides may constitute from about 0.02 wt. % to about 2 wt. %, and in some embodiments, from about 0.05 wt. % to about 1 wt. % of the thermoplastic composition.

In addition to or in lieu of the compounds described above, carboxy-functional compounds may also be employed in the present invention as flow modifiers. The term “carboxy-functional” generally means that the compound contains at least one carboxyl functional group or is capable of possessing such a functional group in the presence of a solvent. The carboxy-functional compound typically has a molecular weight of from about 2,000 grams per mole or less, in some embodiments from about 25 to about 1,000 grams per mole, in some embodiments from about 50 to about 500 grams per mole, and in some embodiments, from about 100 to about 400 grams per mole. The compound may also contain a core formed from one or more aromatic rings (including heteroaromatic) similar in nature to the aromatic constituents of the liquid crystalline polymer. Such an aromatic compound may have the general structure provided below in Formula (V):

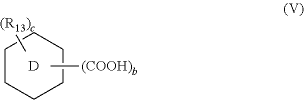

or a metal salt thereof, wherein,

ring D is a 6-membered aromatic ring wherein 1 to 3 ring carbon atoms are optionally replaced by nitrogen or oxygen, wherein each nitrogen is optionally oxidized, and wherein ring D may be optionally fused or linked to a 5- or 6-membered aryl, heteroaryl, cycloalkyl, or heterocyclyl;

R₁₃ is acyl, acyloxy (e.g., acetyloxy), acylamino (e.g., acetylamino), alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy;

b is from 1 to 3, and in some embodiments, from 1 to 2; and

c is from 0 to 4, in some embodiments from 0 to 2, and in some embodiments, from 0 to 1. When the compound is in the form of a metal salt, suitable metal counterions may include transition metal counterions (e.g., copper, iron, etc.), alkali metal counterions (e.g., potassium, sodium, etc.), alkaline earth metal counterions (e.g., calcium, magnesium, etc.), and/or main group metal counterions (e.g., aluminum).

in one embodiment, for example, b is 1 and D is phenyl in Formula (V) such that the carboxy-functional compound is a phenolic acid having the following formula (VI):

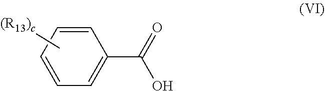

or a metal salt thereof, wherein,

R₁₃ is acyl, acyloxy, acylamino, alkoxy, alkenyl, alkyl, amino, carboxyl, carboxyl ester, hydroxyl, halo, or haloalkyl; and

c is from 0 to 4, in some embodiments from 0 to 2, and in some embodiments, from 0 to 1. Particular examples of such phenolic acid compounds include, for instance, benzoic acid (c is 0); sodium benzoate (c is 0); 3-hydroxybenzoic acid (R₁₃ is OH and c is 1); 4-hydroxybenzoic acid (R₁₃ is OH and c is 1); etc.

In another embodiment, D is phenyl, c is 1, and R₁₃ is phenyl in Formula (V) above such that the carboxy-functional compound is a diphenolic acid compound having the following formula (VII):

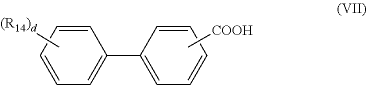

or a metal salt thereof, wherein,

R₁₄ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and

d is from 0 to 4, in some embodiments from 0 to 2, and in some embodiments, from 0 to 1. Particular examples of such diphenolic acid compounds include, for instance, terephthalic acid (R₁₄ is OH and d is 1); isophthalic acid (R₁₄ is OH and d is 1); etc.

In yet another embodiment, ID is naphthenyl in Formula (V) above such that the hydroxy-functional compound is a naphthenic acid having the following formula (VIII):

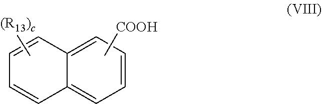

or a metal salt thereof, wherein,

R₁₃ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and

c is from 0 to 4, in some embodiments from 0 to 2, and in some embodiments, from 0 to 1. Particular examples of such naphthenic acid compounds include, for instance, 1-naphthoic acid (c is 0); 2-naphtoic acid (c is 0); 2,6-napthalene dicarboxylic acid (c is 1 and R₁₃ is COOH); 2,3-naphthalene dicarboxylic acid (c is 1 and R₁₃ is COOH); etc.

When employed, carboxy-functional compounds typically constitute from about 0.001 wt. % to about 0.5 wt. %, and in some embodiments, from about 0.005 wt. % to about 0.1 wt. % of the thermoplastic composition. In certain embodiments, the thermoplastic composition may employ a combination of carboxy- and hydroxy-functional compounds. In fact, without intending to be limited by theory, it is believed that such carboxy-functional compounds can combine smaller chains of the polymer together after they have been cut by hydroxy-functional compounds. This helps maintain the mechanical properties of the composition even after its melt viscosity has been reduced. For example, in one particular embodiment, a naphthenic acid (e.g., 2,6-naphthalene dicarboxylic acid) may be employed in combination with a biphenyl hydroxy-functional compound (e.g., 4,4′-biphenol) and/or a metal hydroxide (e.g., aluminum hydroxide). To help achieve the properties desired, the weight ratio of the hydroxy-functional compounds (e.g., 4,4′-biphenol, aluminum hydroxide, etc.) to carboxy-functional compounds (e.g., 2,6-naphthalene dicarboxylic acid) in the composition is typically from about 1 to about 30, in some embodiments from about 2 to about 25, and in some embodiments, from about 5 to about 20.

B. Aromatic Amide Oligomer

As indicated above, an aromatic amide oligomer is also employed as a flow modifier in the thermoplastic composition of the present invention. Such an oligomer can serve as a “flow aid” by altering intermolecular polymer chain interactions, thereby lowering the overall viscosity of the polymer matrix under shear. Contrary to the functional compounds noted above, however, the aromatic amide oligomer does not generally react with the polymer backbone of the liquid crystalline polymer to any appreciable extent. Another benefit of the oligomer is that it is not easily volatized or decomposed. This allows the oligomer to be added to the reaction mixture while it is still at relatively high temperatures. Without intending to be limited by theory, it is believed that active hydrogen atoms of the amide functional groups are capable of forming a hydrogen bond with the backbone of liquid crystalline polyesters or polyesteramides. Such hydrogen bonding strengthens the attachment of the oligomer to the liquid crystalline polymer and thus minimizes the likelihood that it becomes volatilized.

The aromatic amide oligomer generally has a relatively low molecular weight so that it can effectively serve as a flow aid for the polymer composition. For example, the oligomer typically has a molecular weight of about 3,000 grams per mole or less, in some embodiments from about 50 to about 2,000 grams per mole, in some embodiments from about 100 to about 1,500 grams per mole, and in some embodiments, from about 200 to about 1,200 grams per mole. In addition to possessing a relatively low molecular weight, the oligomer also generally possesses high amide functionality so it is capable of undergoing a sufficient degree of hydrogen bonding with the liquid crystalline polymer. The degree of amide functionality for a given molecule may be characterized by its “amide equivalent weight”, which reflects the amount of a compound that contains one molecule of an amide functional group and may be calculated by dividing the molecular weight of the compound by the number of amide groups in the molecule. For example, the aromatic amide oligomer may contain from 1 to 15, in some embodiments from 2 to 10, and in some embodiments, from 2 to 8 amide functional groups per molecule. The amide equivalent weight may likewise be from about 10 to about 1,000 grams per mole or less, in some embodiments from about 50 to about 500 grams per mole, and in some embodiments, from about 100 to about 300 grams per mole.

As indicated above, it is desirable that the amide oligomer is also generally unreactive so that it does not form covalent bonds with the liquid crystalline polymer backbone. To help better minimize reactivity, the oligomer typically contains a core formed from one or more aromatic rings (including heteroaromatic). The oligomer may also contain terminal groups formed from one or more aromatic rings. Such an “aromatic” oligomer thus possesses little, if any, reactivity with the base liquid crystalline polymer. For example, one embodiment of such an aromatic amide oligomer is provided below in Formula (IX):

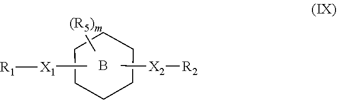

wherein,

ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;

R₅ is halo, haloalkyl, alkyl, alkenyl, aryl, heteroaryl, cycloalkyl, or heterocyclyl;

m is from 0 to 4;

X₁ and X₂ are independently C(O)HN or NHC(O); and

R₁ and R₂ are independently selected from aryl, heteroaryl, cycloalkyl, and heterocyclyl.

In certain embodiments, Ring B may be selected from the following:

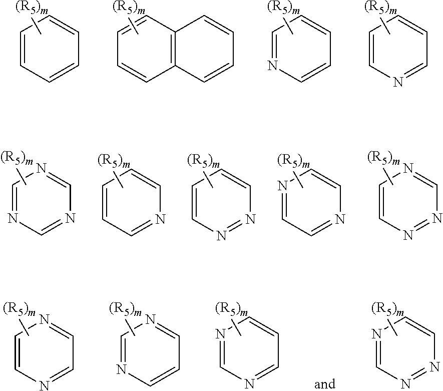

wherein,

m is 0, 1, 2, 3, or 4, in some embodiments m is 0, 1, or 2, in some embodiments m is 0 or 1, and in some embodiments, m is 0; and

R₅ is halo, haloalkyl, alkyl, alkenyl, aryl, heteroaryl, cycloalkyl, or heterocyclyl. Preferably, ring B is phenyl.

In certain embodiments, the oligomer is a di-functional compound in that Ring B is directly bonded to only two (2) amide groups (e.g., C(O)HN or NHC(O)). In such embodiments, m in Formula (IX) is preferably 0. Of course, in certain embodiments, Ring B may also be directly bonded to three (3) or more amide groups. For example, one embodiment of such a compound is provided by general formula (X):

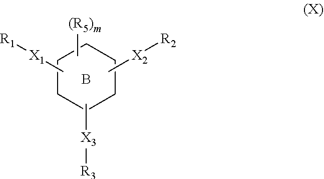

wherein,

ring B, R₅, X₁, X₂, R₁, and R₂ are as defined above;

m is from 0 to 3;

X₃ is C(O)HN or NHC(O); and

R₃ is selected from aryl, heteroaryl, cycloalkyl, and heterocyclyl.

Another embodiment of such a compound is provided by general formula (XI):

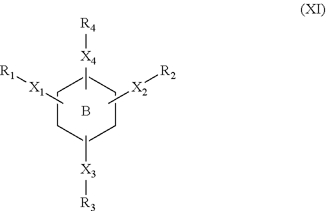

wherein,

ring B, R₅, X₁, X₂, X₃, R₁, R₂, and R₃ are as defined above;

X₄ is C(O)HN or NHC(O); and

R₄ is selected from aryl, heteroaryl, cycloalkyl, and heterocyclyl

In some embodiments, R₁, R₂, R₃, and/or R₄ in the structures noted above may be selected from the following:

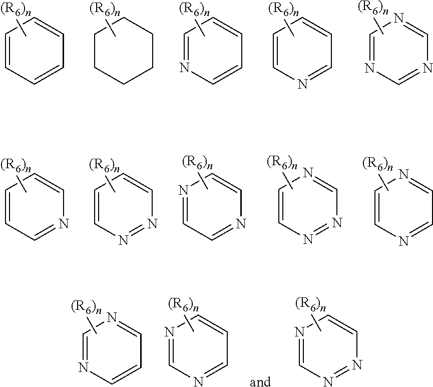

wherein,

n is 0, 1, 2, 3, 4, or 5, in some embodiments n is 0, 1, or 2, and in some embodiments, n is 0 or 1; and

R₆ is halo, haloalkyl, alkyl, alkenyl, aryl, heteroaryl, cycloalkyl, or heterocyclyl.

In one particular embodiment, the aromatic amide oligomer has the following general formula (XII):

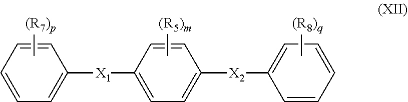

wherein,

X₁ and X₂ are independently C(O)HN or NHC(O);

R₅, R₇, and R₈ are independently selected from halo, haloalkyl, alkyl, alkenyl, aryl, heteroaryl, cycloalkyl, and heterocyclyl;

m is from 0 to 4; and

p and q are independently from 0 to 5.

In another embodiment, the aromatic amide oligomer has the following general formula (XIII):

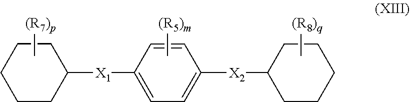

wherein,

X₁, X₂, R₅, R₇, R₈, m, p, and q are as defined above.

For example, m, p, and q in Formula (XII) and (XIII) may be equal to 0 so that the core and terminal aromatic groups are unsubstituted. In other embodiments, m may be 0 and p and q may be from 1 to 5. In such embodiments, for example, R₇ and/or R₈ may be halo (e.g., fluorine). In other embodiments, R₇ and/or R₈ may be aryl (e.g., phenyl) or aryl substituted with an amide group having the structure: —C(O)R₂₂N— or —NR₂₃C(O)—, wherein R₂₂ and R₂₃ are independently selected from hydrogen, alkyl, alkenyl, aryl, heteroaryl, cycloalkyl, and heterocyclyl. In one particular embodiment, for example, R₆ and/or R₇ are phenyl substituted with —C(O)HN— or —NHC(O)—. In yet other embodiments, R₇ and/or R₈ may be heteroaryl (e.g., pyridinyl).

In yet another embodiment, the aromatic amide oligomer has the following general formula (XIII):

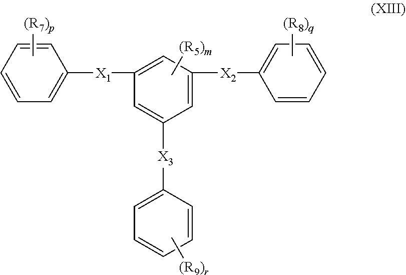

wherein,

X₁, X₂, and X₃ are independently C(O)HN or NHC(O);

R₅, R₇, R₈, and R₉ are independently selected from halo, haloalkyl, alkyl, alkenyl, aryl, heteroaryl, cycloalkyl, and heterocyclyl;

m is from 0 to 3; and

p, q, and r are independently from 0 to 5.

In yet another embodiment, the aromatic amide oligomer has the following general formula (XIV):

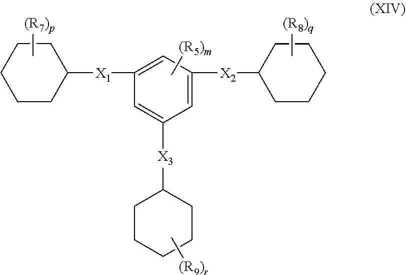

wherein,

X₁, X₂, X₃, R₅, R₇, R₈, R₉, m, p, q, and r are as defined above.

For example, in certain embodiments, m, p, q, and r in Formula (XIII) and (XIV) may be equal to 0 so that the core and terminal aromatic groups are unsubstituted. In other embodiments, m may be 0 and p, q, and r may be from 1 to 5. In such embodiments, for example, R₇, R₈, and/or R₉ may be halo (e.g., fluorine). In other embodiments, R₇, R₈, and/or R₉ may be aryl (e.g., phenyl) or aryl substituted with an amide group having the structure: —C(O)R₂₂N— or —NR₂₃C(O)—, wherein R₂₂ and R₂₃ are independently selected from hydrogen, alkyl, alkenyl, aryl, heteroaryl, cycloalkyl, and heterocyclyl. In one particular embodiment, for example, R₇, R₈, and/or R₉ are phenyl substituted with —C(O)HN— or —NHC(O)—. In yet other embodiments, R₇, R₈, and/or R₉ may be heteroaryl (e.g., pyridinyl).

Specific embodiments of the aromatic amide oligomer of the present invention are also set forth in the table below:

| Cmpd # | Structure | Name |
|---|---|---|
| A | 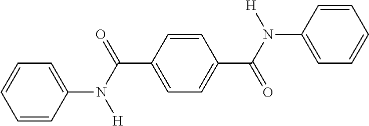 [SMILES: O=C(Nc1ccccc1)c1ccc(C(=O)Nc2ccccc2)cc1] | N1,N4- diphenylterephthalamide |
| B | 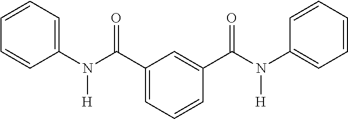 [SMILES: O=C(Nc1ccccc1)c1cccc(C(=O)Nc2ccccc2)c1] | N1,N4- diphenylisoterephthalamide |
| C | 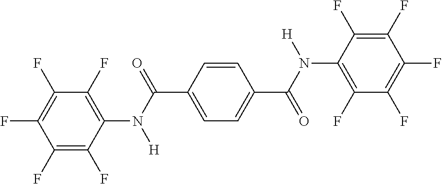 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl) terephthalamide |
| D | 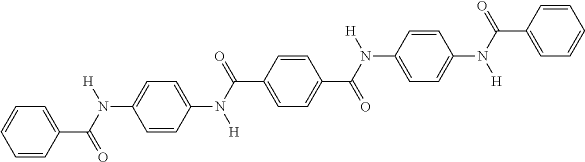 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl) terephthalamide |
| E | 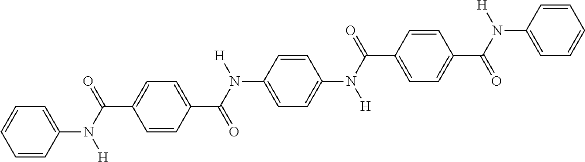 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl) benzoyl]amino] phenyl] terephthalamide |
| F1 | 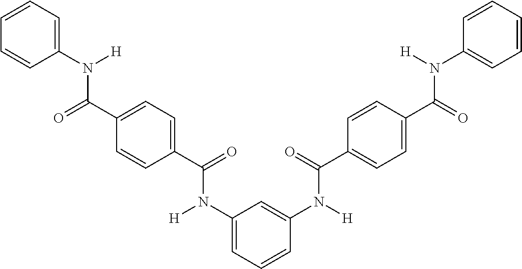 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl) benzoyl]amino] phenyl] terephthalamide |
| F2 | 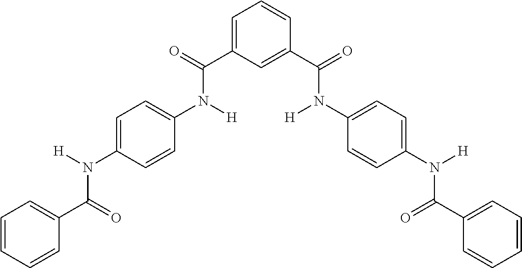 [SMILES: O=C(Nc1ccc(NC(=O)c2cccc(C(=O)Nc3ccc(NC(=O)c4ccccc4)cc3)c2)cc1)c1ccccc1] | N1,N3-bis(4- benzamidophenyl) benzene-1,3- dicarboxamide |
| G1 | 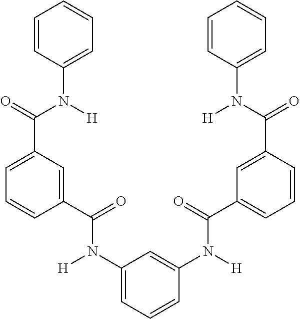 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl) benzoyl]amino] phenyl] benzene-1,3-dicarboxamide |
| G2 | 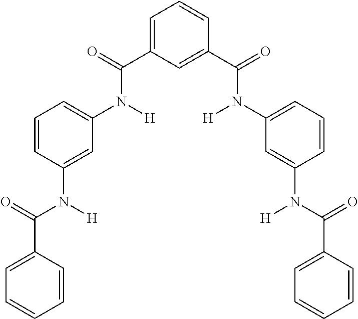 [SMILES: O=C(Nc1cccc(NC(=O)c2cccc(C(=O)Nc3cccc(NC(=O)c4ccccc4)c3)c2)c1)c1ccccc1] | N1,N3-bis(3- benzamidophenyl) benzene-1,3- dicarboxamide |
| H | 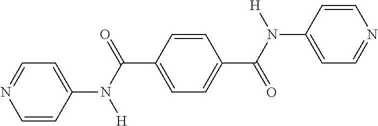 [SMILES: O=C(Nc1ccncc1)c1ccc(C(=O)Nc2ccncc2)cc1] | N1,N4-bis(4-pyridyl) terephthalamide |
| I | 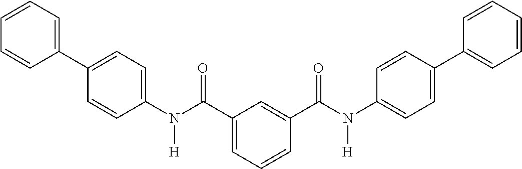 [SMILES: O=C(Nc1ccc(-c2ccccc2)cc1)c1cccc(C(=O)Nc2ccc(-c3ccccc3)cc2)c1] | N1,N3-bis(4-phenylphenyl) benzene- 1,3-dicarboxamide |
| J | 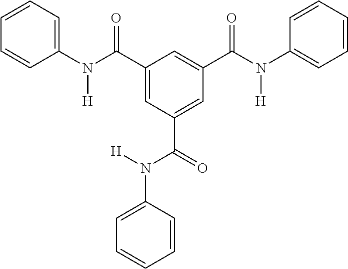 [SMILES: O=C(Nc1ccccc1)c1cc(C(=O)Nc2ccccc2)cc(C(=O)Nc2ccccc2)c1] | N1,N3,N5- triphenylbenzene-1,3,5- tricarboxamide |
| K | 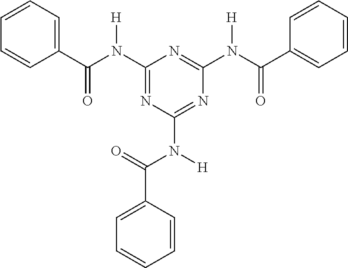 [SMILES: O=C(Nc1nc(NC(=O)c2ccccc2)nc(NC(=O)c2ccccc2)n1)c1ccccc1] | N-(4,6-dibenzamido- 1,3,5-triazin-2- yl)benzamide |
| J1 | 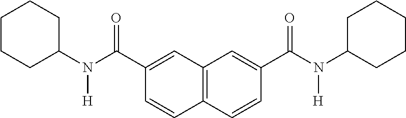 [SMILES: O=C(NC1CCCCC1)c1ccc2ccc(C(=O)NC3CCCCC3)cc2c1] | N2,N7- dicyclohexylnaphthalene- 2,7-dicarboxamide |
| J2 | 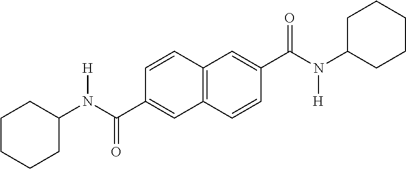 [SMILES: O=C(NC1CCCCC1)c1ccc2cc(C(=O)NC3CCCCC3)ccc2c1] | N2,N6- dicyclohexylnaphthalene- 2,6-dicarboxamide |
| K1 | 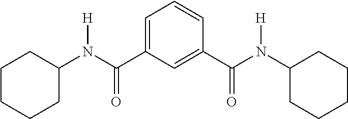 [SMILES: O=C(NC1CCCCC1)c1cccc(C(=O)NC2CCCCC2)c1] | 1,3-Benzenedicarboxamide, N1,N3-dicyclohexyl |
| K2 | 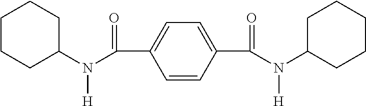 [SMILES: O=C(NC1CCCCC1)c1ccc(C(=O)NC2CCCCC2)cc1] | 1,4-Benzenedicarboxamide, N1,N3-dicyclohexyl |

The relative proportion of the liquid crystalline polymer and the aromatic amide oligomer in the composition may be selected to help achieve a balance between viscosity and mechanical properties. More particularly, high oligomer contents can result in low viscosity, but too high of a content may reduce the viscosity to such an extent that the oligomer adversely impacts the melt strength of the polymer. In most embodiments, for example, the aromatic amide oligomer, or mixtures thereof, may be employed in an amount of from about 0.1 to about 5 parts, in some embodiments from about 0.2 to about 4 parts, and in some embodiments, from about 0.3 to about 1.5 parts by weight relative to 100 parts by weight of the liquid crystalline polymer. The aromatic amide oligomers may, for example, constitute from about 0.1 wt. % to about 5 wt. %, in some embodiments from about 0.2 wt. % to about 4 wt. %, and in some embodiments, from about 0.3 wt. % to about 1.5 wt. % of the thermoplastic composition.

### III. Other Additives

In addition to the components identified above, various other additives may also be incorporated in the thermoplastic composition if desired. For example, fibers may be employed in the thermoplastic composition to improve the mechanical properties. Such fibers generally have a high degree of tensile strength relative to their mass. For example, the ultimate tensile strength of the fibers (determined in accordance with ASTM D2101) is typically from about 1,000 to about 15,000 Megapascals (“MPa”), in some embodiments from about 2,000 MPa to about 10,000 MPa, and in some embodiments, from about 3,000 MPa to about 6,000 MPa. To help maintain an insulative property, which is often desirable for use in electronic components, the high strength fibers may be formed from materials that are also generally insulative in nature, such as glass, ceramics (e.g., alumina or silica), aramids (e.g., Kevlar® marketed by E. DuPont de Nemours, Wilmington, Del.), polyolefins, polyesters, etc., as well as mixtures thereof. Glass fibers are particularly suitable, such as E-glass, A-glass, C-glass, D-glass, AR-glass, R-glass, S1-glass, S2-glass, etc., and mixtures thereof.

The volume average length of the fibers may be from about 50 to about 400 micrometers, in some embodiments from about 80 to about 250 micrometers, in some embodiments from about 100 to about 200 micrometers, and in some embodiments, from about 110 to about 180 micrometers. The fibers may also have a narrow length distribution. That is, at least about 70% by volume of the fibers, in some embodiments at least about 80% by volume of the fibers, and in some embodiments, at least about 90% by volume of the fibers have a length within the range of from about 50 to about 400 micrometers, in some embodiments from about 80 to about 250 micrometers, in some embodiments from about 100 to about 200 micrometers, and in some embodiments, from about 110 to about 180 micrometers. Such a weight average length and narrow length distribution can further help achieve a desirable combination of strength and flowability, which enables it to be uniquely suited for molded parts with a small dimensional tolerance.

In addition to possessing the length characteristics noted above, the fibers may also have a relatively high aspect ratio (average length divided by nominal diameter) to help improve the mechanical properties of the resulting thermoplastic composition. For example, the fibers may have an aspect ratio of from about 2 to about 50, in some embodiments from about 4 to about 40, and in some embodiments, from about 5 to about 20 are particularly beneficial. The fibers may, for example, have a nominal diameter of about 10 to about 35 micrometers, and in some embodiments, from about 15 to about 30 micrometers.

The relative amount of the fibers in the thermoplastic composition may also be selectively controlled to help achieve the desired mechanical properties without adversely impacting other properties of the composition, such as its flowability. For example, the fibers typically constitute from about 2 wt. % to about 40 wt. %, in some embodiments from about 5 wt. % to about 35 wt. %, and in some embodiments, from about 6 wt. % to about 30 wt. % of the thermoplastic composition. Although the fibers may be employed within the ranges noted above, one particularly beneficial and surprising aspect of the present invention is that small fiber contents may be employed while still achieving the desired mechanical properties. Without intending to be limited by theory, it is believed that the narrow length distribution of the fibers can help achieve excellent mechanical properties, thus allowing for the use of a smaller amount of fibers. For example, the fibers can be employed in small amounts such as from about 2 wt. % to about 20 wt. %, in some embodiments, from about 5 wt. % to about 16 wt. %, and in some embodiments, from about 6 wt. % to about 12 wt. %.

Still other additives that can be included in the composition may include, for instance, antimicrobials, fillers, pigments, antioxidants, stabilizers, surfactants, waxes, solid solvents, and other materials added to enhance properties and processability. For example, mineral fillers may be employed in the thermoplastic composition to help achieve the desired mechanical properties and/or appearance. When employed, such mineral fillers typically constitute from about 1 wt. % to about 40 wt. %, in some embodiments from about 2 wt. % to about 35 wt. %, and in some embodiments, from about 5 wt. % to about 30 wt. % of the thermoplastic composition. Clay minerals may be particularly suitable for use in the present invention. Examples of such clay minerals include, for instance, talc (Mg₃Si₄O₁₀(OH)₂), halloysite (Al₂Si₂O₅(OH)₄), kaolinite (Al₂Si₂O₅(OH)₄), illite ((K,H₃O)(Al,Mg,Fe)₂(Si,Al)₄O₁₀[(OH)₂.n(H₂O)]), montmorillonite (Na,Ca)_{0.33}(Al,Mg)₂Si₄O₁₀(OH)₂.nH₂O), vermiculite ((MgFe,Al)₃(Al,Si)₄O₁₀(OH)₂.4H₂O), palygorskite ((Mg,Al)₂Si₄O₁₀(OH).4(H₂O)), pyrophyllite (Al₂Si₄O₁₀(OH)₂), etc., as well as combinations thereof. In lieu of, or in addition to, clay minerals, still other mineral fillers may also be employed. For example, other suitable silicate fillers may also be employed, such as calcium silicate, aluminum silicate, mica, diatomaceous earth, wollastonite, and so forth. Mica, for instance, may be particularly suitable. There are several chemically distinct mica species with considerable variance in geologic occurrence, but all have essentially the same crystal structure. As used herein, the term “mica” is meant to generically include any of these species, such as muscovite (KAl₂(AlSi₃)O₁₀(OH)₂), biotite (K(Mg,Fe)₃(AlSi₃)O₁₀(OH)₂), phlogopite (KMg₃(AlSi₃)O₁₀(OH)₂), lepidolite (K(Li,Al)₂₋₃(AlSi₃)O₁₀(OH)₂), glauconite (K,Na)(Al,Mg,Fe)₂(Si,Al)₄O₁₀(OH)₂), etc., as well as combinations thereof.

Lubricants may also be employed in the thermoplastic composition that are capable of withstanding the processing conditions of the liquid crystalline polymer without substantial decomposition. Examples of such lubricants include fatty acids esters, the salts thereof, esters, fatty acid amides, organic phosphate esters, and hydrocarbon waxes of the type commonly used as lubricants in the processing of engineering plastic materials, including mixtures thereof. Suitable fatty acids typically have a backbone carbon chain of from about 12 to about 60 carbon atoms, such as myristic acid, palmitic acid, stearic acid, arachic acid, montanic acid, octadecinic acid, parinric acid, and so forth. Suitable esters include fatty acid esters, fatty alcohol esters, wax esters, glycerol esters, glycol esters and complex esters. Fatty acid amides include fatty primary amides, fatty secondary amides, methylene and ethylene bisamides and alkanolamides such as, for example, palmitic acid amide, stearic acid amide, oleic acid amide, N,N′-ethylenebisstearamide and so forth. Also suitable are the metal salts of fatty acids such as calcium stearate, zinc stearate, magnesium stearate, and so forth; hydrocarbon waxes, including paraffin waxes, polyolefin and oxidized polyolefin waxes, and microcrystalline waxes. Particularly suitable lubricants are acids, salts, or amides of stearic acid, such as pentaerythritol tetrastearate, calcium stearate, or N,N′-ethylenebisstearamide. When employed, the lubricant(s) typically constitute from about 0.05 wt. % to about 1.5 wt. %, and in some embodiments, from about 0.1 wt. % to about 0.5 wt. % (by weight) of the thermoplastic composition.

### IV. Processing Technique

The manner in which the flow modifiers and the liquid crystalline polymer are combined may vary as is known in the art. For instance, because the aromatic amide oligomer does not react with the backbone of the polymer to any appreciable extent, it may be generally applied during any stage of processing, including during and/or after formation of the liquid crystalline polymer. In one embodiment, for example, the aromatic amide oligomer may be supplied during one or more stages of the polymerization of the liquid crystalline polymer (e.g., acetylation, melt polymerization, solid state polymerization, etc.). For example, the aromatic amide oligomer may be added to the melt polymerization apparatus. Although it may be introduced at any time, it is typically desired to apply the oligomer before melt polymerization has been initiated, and typically in conjunction with the precursor monomers for the liquid crystalline polymer. Of course, in other embodiments, the aromatic amide oligomer may simply be melt blended with the liquid crystalline polymer.

In contrast to the aromatic amide oligomer, the functional compound is capable of undergoing extensive reactions with the backbone of the liquid crystalline polymer, often resulting in chain scission. For this reason, it is typically desired that the functional compound is blended with the liquid crystalline polymer only after it is formed. Melt blending may occur, for instance, within a temperature range of from about 200° C. to about 450° C., in some embodiments, from about 220° C. to about 400° C., and in some embodiments, from about 250° C. to about 350° C. to form the thermoplastic composition. Any of a variety of melt blending techniques may generally be employed in the present invention. For example, the components (e.g., liquid crystalline polymer, flow modifiers, etc.) may be supplied separately or in combination to an extruder that includes at least one screw rotatably mounted and received within a barrel (e.g., cylindrical barrel) and may define a feed section and a melting section located downstream from the feed section along the length of the screw.

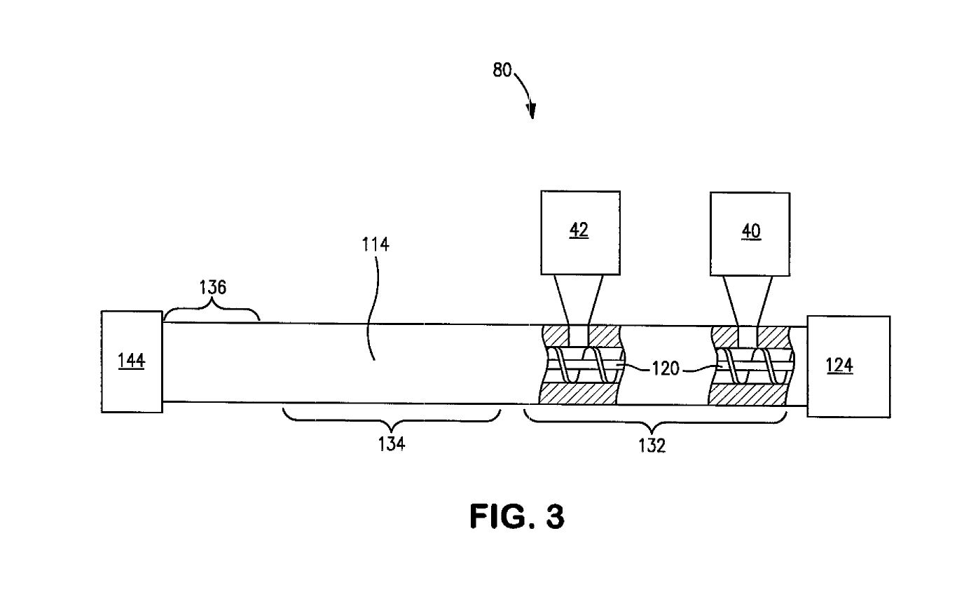

The extruder may be a single screw or twin screw extruder. Referring to FIG. 3, for example, one embodiment of a single screw extruder 80 is shown that contains a housing or barrel 114 and a screw 120 rotatably driven on one end by a suitable drive 124 (typically including a motor and gearbox). If desired, a twin-screw extruder may be employed that contains two separate screws. The configuration of the screw is not particularly critical to the present invention and it may contain any number and/or orientation of threads and channels as is known in the art. As shown in FIG. 3, for example, the screw 120 contains a thread that forms a generally helical channel radially extending around a core of the screw 120. A hopper 40 is located adjacent to the drive 124 for supplying a base liquid crystalline polymer composition (optionally including an aromatic amide oligomer) through an opening in the barrel 114 to the feed section 132. Opposite the drive 124 is the output end 144 of the extruder 80, where extruded plastic is output for further processing.

A feed section 132 and melt section 134 are defined along the length of the screw 120. The feed section 132 is the input portion of the barrel 114 where the base liquid crystalline polymer is added. The melt section 134 is the phase change section in which the liquid crystalline polymer is changed from a solid to a liquid. While there is no precisely defined delineation of these sections when the extruder is manufactured, it is well within the ordinary skill of those in this art to reliably identify the feed section 132 and the melt section 134 in which phase change from solid to liquid is occurring. Although not necessarily required, the extruder 80 may also have a mixing section 136 that is located adjacent to the output end of the barrel 114 and downstream from the melt section 134. If desired, one or more distributive and/or dispersive mixing elements may be employed within the mixing and/or melting sections of the extruder. Suitable distributive mixers for single screw extruders may include, for instance, Saxon, DuImage, Cavity Transfer mixers, etc. Likewise, suitable dispersive mixers may include Blister ring, Leroy/Maddock, CRD mixers, etc. As is well known in the art, the mixing may be further improved by using pins in the barrel that create a folding and reorientation of the polymer melt, such as those used in Buss Kneader extruders, Cavity Transfer mixers, and Vortex Intermeshing Pin mixers.

The flow aid(s) (e.g., non-functional and/or functional compounds) may be added at any section of the extruder, such as to the hopper 40, feed section 132, melt section 134, and/or mixing section 136. In one embodiment, for example, the flow aid(s) may be added downstream from the liquid crystalline polymer, such as to the melt section 134 and/or mixing section 136.

When employed, fibers can also be added to the hopper 40 or at a location downstream therefrom. In one particular embodiment, fibers may be added a location downstream from the point at which the liquid crystalline polymer is supplied, but yet prior to the melting section. Likewise, it may also be desired to add flow modifier(s) downstream from the addition of the fibers. In FIG. 3, for instance, a hopper 42 is shown that is located within a zone of the feed section 132 of the extruder 80. The fibers supplied to the hopper 42 may be initially relatively long, such as having a volume average length of from about 1,000 to about 5,000 micrometers, in some embodiments from about 2,000 to about 4,500 micrometers, and in some embodiments, from about 3,000 to about 4,000 micrometers. Nevertheless, by supplying these long fibers at a location where the liquid crystalline polymer is still in a solid state, the polymer can act as an abrasive agent for reducing the size of the fibers to a volume average length and length distribution as indicated above.

If desired, the ratio of the length (“L”) to diameter (“D”) of the screw may be selected to achieve an optimum balance between throughput and fiber length reduction. The L/D value may, for instance, range from about 15 to about 50, in some embodiments from about 20 to about 45, and in some embodiments from about 25 to about 40. The length of the screw may, for instance, range from about 0.1 to about 5 meters, in some embodiments from about 0.4 to about 4 meters, and in some embodiments, from about 0.5 to about 2 meters. The diameter of the screw may likewise be from about 5 to about 150 millimeters, in some embodiments from about 10 to about 120 millimeters, and in some embodiments, from about 20 to about 80 millimeters. The L.D ratio of the screw after the point at which the fibers are supplied may also be controlled within a certain range. For example, the screw has a blending length (“L_{B}”) that is defined from the point at which the fibers are supplied to the extruder to the end of the screw, the blending length being less than the total length of the screw. As noted above, it may be desirable to add the fibers before the liquid crystalline polymer is melted, which means that the L_{B}/D ratio would be relatively high. However, too high of a L_{B}/D ratio could result in degradation of the polymer. Therefore, the L_{B}/D ratio of the screw after the point at which the fibers are supplied is typically from about 4 to about 20, in some embodiments from about 5 to about 15, and in some embodiments, from about 6 to about 10.

In addition to the length and diameter, other aspects of the extruder may also be selected to help achieve the desired fiber length. For example, the speed of the screw may be selected to achieve the desired residence time, shear rate, melt processing temperature, etc. Generally, an increase in frictional energy results from the shear exerted by the turning screw on the materials within the extruder and results in the fracturing of the fibers, if employed. The degree of fracturing may depend, at least in part, on the screw speed. For example, the screw speed may range from about 50 to about 200 revolutions per minute (“rpm”), in some embodiments from about 70 to about 150 rpm, and in some embodiments, from about 80 to about 120 rpm. The apparent shear rate during melt blending may also range from about 100 seconds⁻¹ to about 10,000 seconds⁻¹, in some embodiments from about 500 seconds⁻¹ to about 5000 seconds⁻¹, and in some embodiments, from about 800 seconds⁻¹ to about 1200 seconds⁻¹. The apparent shear rate is equal to 4 Q/πR³, where Q is the volumetric flow rate (“m³/s”) of the polymer melt and R is the radius (“m”) of the capillary (e.g., extruder die) through which the melted polymer flows.

In the embodiments described above, the length of the fibers is reduced within the extruder. It should be understood, however, that this is by no means a requirement of the present invention. For example, the fibers may simply be supplied to the extruder at the desired length. In such embodiments, the fibers may, for example, be supplied at the mixing and/or melting sections of the extruder, or even at the feed section in conjunction with the liquid crystalline polymer. In yet other embodiments, fibers may not be employed at all.

Once formed, the thermoplastic composition may be molded into any of a variety of different shaped parts using techniques as is known in the art. For example, the shaped parts may be molded using a one-component injection molding process in which dried and preheated plastic granules are injected into the mold. Regardless of the molding technique employed, it has been discovered that the thermoplastic composition of the present invention, which possesses the unique combination of high flowability and good mechanical properties, is particularly well suited for parts having a small dimensional tolerance. Such parts, for example, generally contain at least one micro-sized dimension (e.g., thickness, width, height, etc.), such as from about 500 micrometers or less, in some embodiments from about 100 to about 450 micrometers, and in some embodiments, from about 200 to about 400 micrometers.

One such part is a fine pitch electrical connector. More particularly, such electrical connectors are often employed to detachably mount a central processing unit (“CPU”) to a printed circuit board. The connector may contain insertion passageways that are configured to receive contact pins. These passageways are defined by opposing walls, which may be formed from a thermoplastic resin. To help accomplish the desired electrical performance, the pitch of these pins is generally small to accommodate a large number of contact pins required within a given space. This, in turn, requires that the pitch of the pin insertion passageways and the width of opposing walls that partition those passageways are also small. For example, the walls may have a width of from about 500 micrometers or less, in some embodiments from about 100 to about 450 micrometers, and in some embodiments, from about 200 to about 400 micrometers. In the past, it has often been difficult to adequately fill a mold of such a thin width with a thermoplastic resin. Due to its unique properties, however, the thermoplastic composition of the present invention is particularly well suited to form the walls of a fine pitch connector.

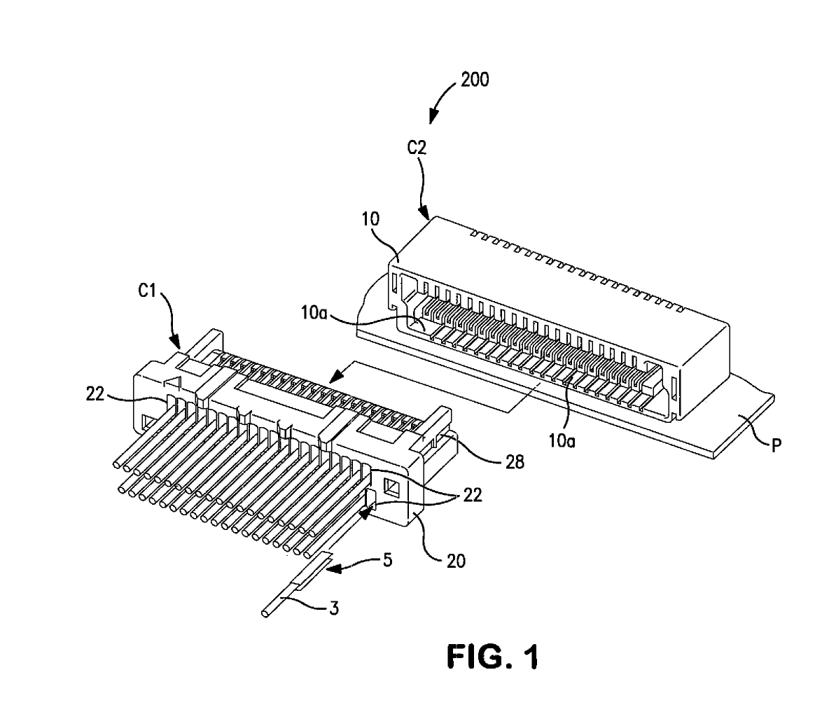

One particularly suitable fine pitch electrical connector is shown in FIG. 1. An electrical connector 200 is shown that a board-side portion C2 that can be mounted onto the surface of a circuit board P. The connector 200 may also include a wiring material-side portion C1 structured to connect discrete wires 3 to the circuit board P by being coupled to the board-side connector C2. The board-side portion C2 may include a first housing 10 that has a fitting recess 10a into which the wiring material-side connector C1 is fitted and a configuration that is slim and long in the widthwise direction of the housing 10. The wiring material-side portion C1 may likewise include a second housing 20 that is slim and long in the widthwise direction of the housing 20. In the second housing 20, a plurality of terminal-receiving cavities 22 may be provided in parallel in the widthwise direction so as to create a two-tier array including upper and lower terminal-receiving cavities 22. A terminal 5, which is mounted to the distal end of a discrete wire 3, may be received within each of the terminal-receiving cavities 22. If desired, locking portions 28 (engaging portions) may also be provided on the housing 20 that correspond to a connection member (not shown) on the board-side connector C2.

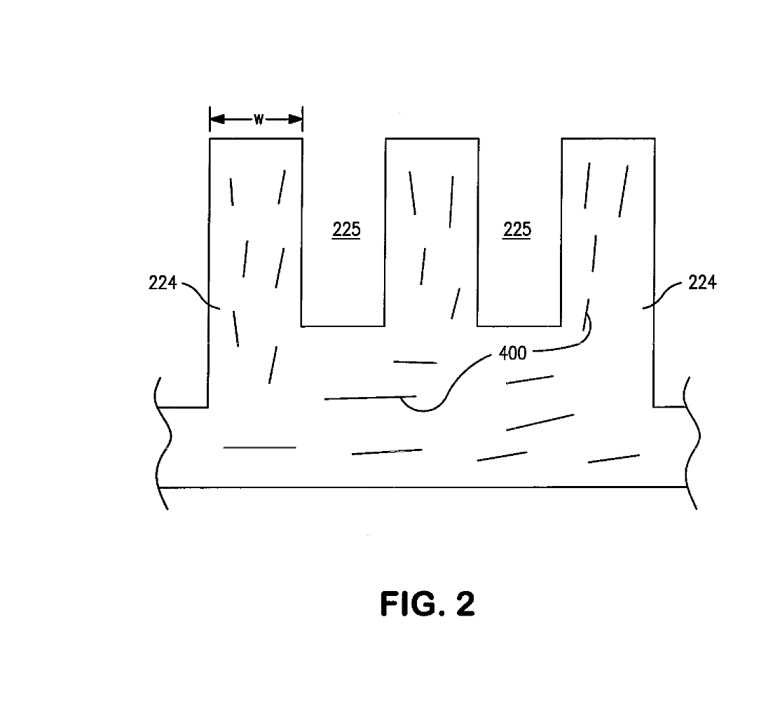

As discussed above, the interior walls of the first housing 10 and/or second housing 20 may have a relatively small width dimension, and can be formed from the thermoplastic composition of the present invention. The walls are, for example, shown in more detail in FIG. 2. As illustrated, insertion passageways or spaces 225 are defined between opposing walls 224 that can accommodate contact pins. The walls 224 have a width “w” that is within the ranges noted above. When the walls 224 are formed from a thermoplastic composition containing fibers (e.g., element 400), such fibers may have a volume average length and narrow length distribution within a certain range to best match the width of the walls. For example, the ratio of the width of at least one of the walls to the volume average length of the fibers is from about 0.8 to about 3.2, in some embodiments from about 1.0 to about 3.0, and in some embodiments, from about 1.2 to about 2.9.

In addition to or in lieu of the walls, it should also be understood that any other portion of the housing may also be formed from the thermoplastic composition of the present invention. For example, the connector may also include a shield that encloses the housing. Some or all of the shield may be formed from the thermoplastic composition of the present invention. For example, the housing and the shield can each be a one-piece structure unitarily molded from the thermoplastic composition. Likewise, the shield can be a two-piece structure that includes a first shell and a second shell, each of which may be formed from the thermoplastic composition of the present invention.

Of course, the thermoplastic composition may also be used in a wide variety of other components having a small dimensional tolerance. For example, the thermoplastic composition may be molded into a planar substrate for use in an electronic component. The substrate may be thin, such as having a thickness of about 500 micrometers or less, in some embodiments from about 100 to about 450 micrometers, and in some embodiments, from about 200 to about 400 micrometers. Examples of electronic components that may employ such a substrate include, for instance, cellular telephones, laptop computers, small portable computers (e.g., ultraportable computers, netbook computers, and tablet computers), wrist-watch devices, pendant devices, headphone and earpiece devices, media players with wireless communications capabilities, handheld computers (also sometimes called personal digital assistants), remote controllers, global positioning system (GPS) devices, handheld gaming devices, battery covers, speakers, integrated circuits (e.g., SIM cards), etc.

In one embodiment, for example, the planar substrate may be applied with one or more conductive elements using a variety of known techniques (e.g., laser direct structuring, electroplating, etc.). The conductive elements may serve a variety of different purposes. In one embodiment, for example, the conductive elements form an integrated circuit, such as those used in SIM cards. In another embodiment, the conductive elements form antennas of a variety of different types, such as antennae with resonating elements that are formed from patch antenna structures, inverted-F antenna structures, closed and open slot antenna structures, loop antenna structures, monopoles, dipoles, planar inverted-F antenna structures, hybrids of these designs, etc. The resulting antenna structures may be incorporated into the housing of a relatively compact portable electronic component, such as described above, in which the available interior space is relatively small.

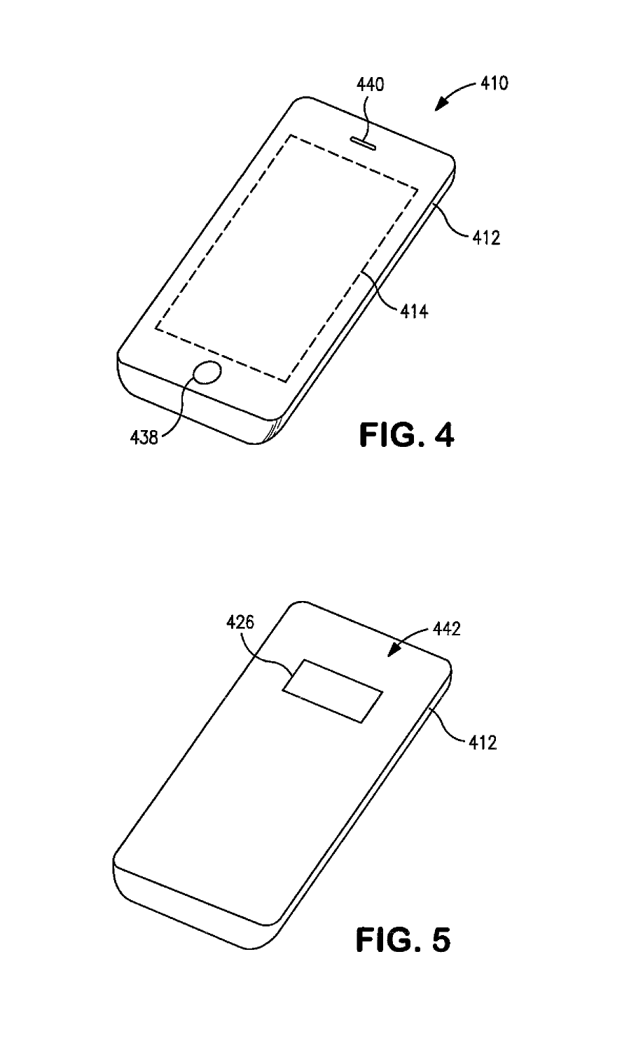

One particularly suitable electronic component that includes an antenna structure is shown in FIGS. 4-5 is a handheld device 410 with cellular telephone capabilities. As shown in FIG. 4, the device 410 may have a housing 412 formed from plastic, metal, other suitable dielectric materials, other suitable conductive materials, or combinations of such materials. A display 414 may be provided on a front surface of the device 410, such as a touch screen display. The device 410 may also have a speaker port 440 and other input-output ports. One or more buttons 438 and other user input devices may be used to gather user input. As shown in FIG. 5, an antenna structure 426 is also provided on a rear surface 442 of device 410, although it should be understood that the antenna structure can generally be positioned at any desired location of the device. As indicated above, the antenna structure 426 may contain a planar substrate that is formed from the thermoplastic composition of the present invention. The antenna structure may be electrically connected to other components within the electronic device using any of a variety of known techniques. For example, the housing 412 or a part of housing 412 may serve as a conductive ground plane for the antenna structure 426.

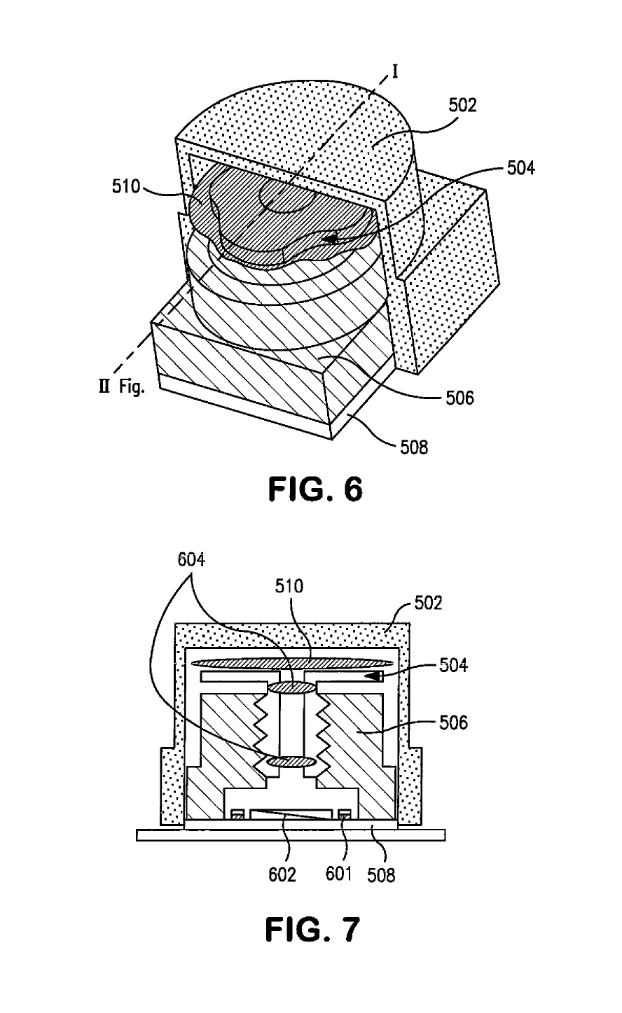

A planar substrate that is formed form the thermoplastic composition of the present invention may also be employed in other applications. For example, in one embodiment, the planar substrate may be used to form a base of a compact camera module (“CCM”), which is commonly employed in wireless communication devices (e.g., cellular phone). Referring to FIGS. 6-7, for example, one particular embodiment of a compact camera module 500 is shown in more detail. As shown, the compact camera module 500 contains a lens assembly 504 that overlies a base 506. The base 506, in turn, overlies an optional main board 508. Due to their relatively thin nature, the base 506 and/or main board 508 are particularly suited to be formed from the thermoplastic composition of the present invention as described above. The lens assembly 504 may have any of a variety of configurations as is known in the art, and may include fixed focus-type lenses and/or auto focus-type lenses. In one embodiment, for example, the lens assembly 504 is in the form of a hollow barrel that houses lenses 604, which are in communication with an image sensor 602 positioned on the main board 508 and controlled by a circuit 601. The barrel may have any of a variety of shapes, such as rectangular, cylindrical, etc. In certain embodiments, the barrel may also be formed from the thermoplastic composition of the present invention and have a wall thickness within the ranges noted above. It should be understood that other parts of the cameral module may also be formed from the thermoplastic composition of the present invention. For example, as shown, a polymer film 510 (e.g., polyester film) and/or thermal insulating cap 502 may cover the lens assembly 504. In some embodiments, the film 510 and/or cap 502 may also be formed from the thermoplastic composition of the present invention.

The present invention may be better understood with reference to the following examples.

### Test Methods

Melt Viscosity:

The melt viscosity (Pa-s) was determined in accordance with ISO Test No. 11443 at 350° C. and at a shear rate of 1000 s⁻¹ using a Dynisco LCR7001 capillary rheometer. The rheometer orifice (die) had a diameter of 1 mm, length of 20 mm, L/D ratio of 20.1, and an entrance angle of 180°. The diameter of the barrel was 9.55 mm±0.005 mm and the length of the rod was 233.4 mm.

Melting Temperature:

The melting temperature (“Tm”) was determined by differential scanning calorimetry (“DSC”) as is known in the art. The melting temperature is the differential scanning calorimetry (DSC) peak melt temperature as determined by ISO Test No. 11357. Under the DSC procedure, samples were heated and cooled at 20° C. per minute as stated in ISO Standard 10350 using DSC measurements conducted on a TA Q2000 Instrument.

Deflection Temperature Under Load (“DTUL”):

The deflection under load temperature was determined in accordance with ISO Test No. 75-2 (technically equivalent to ASTM D648-07). More particularly, a test strip sample having a length of 80 mm, thickness of 10 mm, and width of 4 mm was subjected to an edgewise three-point bending test in which the specified load (maximum outer fibers stress) was 1.8 Megapascals. The specimen was lowered into a silicone oil bath where the temperature is raised at 2° C. per minute until it deflects 0.25 mm (0.32 mm for ISO Test No. 75-2).

Tensile Modulus, Tensile Stress, and Tensile Elongation:

Tensile properties are tested according to ISO Test No. 527 (technically equivalent to ASTM D638). Modulus and strength measurements are made on the same test strip sample having a length of 80 mm, thickness of 10 mm, and width of 4 mm. The testing temperature is 23° C., and the testing speeds are 1 or 5 mm/min.

Flexural Modulus, Flexural Stress, and Flexural Strain:

Flexural properties are tested according to ISO Test No. 178 (technically equivalent to ASTM D790). This test is performed on a 64 mm support span. Tests are run on the center portions of uncut ISO 3167 multi-purpose bars. The testing temperature is 23° C. and the testing speed is 2 mm/min.

Notched Charpy Impact Strength:

Notched Charpy properties are tested according to ISO Test No. ISO 179-1) (technically equivalent to ASTM D256, Method B). This test is run using a Type A notch (0.25 mm base radius) and Type 1 specimen size (length of 80 mm, width of 10 mm, and thickness of 4 mm). Specimens are cut from the center of a multi-purpose bar using a single tooth milling machine. The testing temperature is 23° C.

Fiber Length:

The volume average fiber length is determined by initially placing several pellet samples (e.g., 7 or 8) in a muffle furnace at 420° C. overnight. The resulting ash is immersed in an aqueous solution containing a glycerol surfactant to disperse the glass fibers. The aqueous solution is then placed on a glass slide and images are collected via image analysis system. Glass fibers are selectively chosen from the images by ImagePro™ software, and the software automatically measures the length of the selected glass fiber based on calibrated length. Measurement continues until at least 500 glass fibers are counted. Then, the volume average fiber length and distribution are calculated.

Weldline Strength:

The weldline strength is determined by first forming an injection molded line grid array (“LGA”) connector (size of 49 mm×39 mm×1 mm) from a thermoplastic composition sample as is well known in the art. Once formed, the LGA connector is placed on a sample holder. The center of the connector is then subjected to a tensile force by a rod moving at a speed of 5.08 millimeters per minute. The peak stress is recorded as an estimate of the weldline strength.

### Synthesis of N1,N4-diphenylterephthalamide Compound A

The synthesis of Compound A from terephthaloyl chloride and aniline may be performed according to the following scheme:

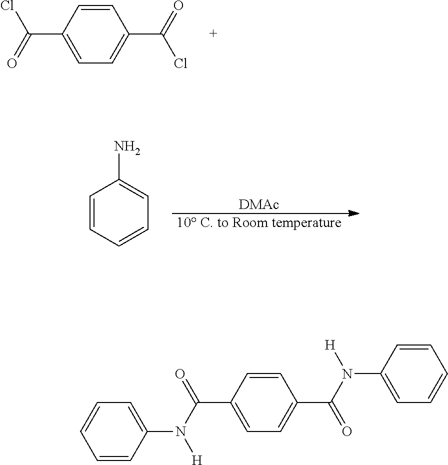

The experimental set up may consist of a 2 L glass beaker equipped with a glass rod stirrer coupled with an overhead mechanical stirrer. Dimethyl acetamide (“DMAc”) (3 L) may be added to the beaker and the beaker may be immersed in an ice bath to cool the system to 10-15° C. Then aniline (481.6 g) may be added to the solvent with constant stirring, the resultant mixture was cooled to 10-15° C. Terephthaloyl chloride (300 g) may be added gradually to the cooled stirred mixture such that the temperature of the reaction is maintained below 30° C. The acid chloride may be added over a period of one-two hours, after which the mixture may be stirred for another three hours at 10-15° C. and then at room temperature overnight. The reaction mixture may be milky white (a fine suspension of the product in the solvent) and vacuum filtered using a filter paper and a Buchner funnel. The crude product may be washed with acetone (2 L) and then washed with hot water (2 L). The product may then be air dried over night at room temperature and dried in a vacuum oven 150° C. for 4-6 hours. The product (464.2 g) may be a highly crystalline white solid. The melting point may be 346-348° C., as determined by differential scanning calorimetry (“DSC”).

### Synthesis of N1,N4-diphenylisoterephthanalide Compound B

The synthesis of Compound B from isophthaloyl chloride and aniline may be performed according to the following scheme:

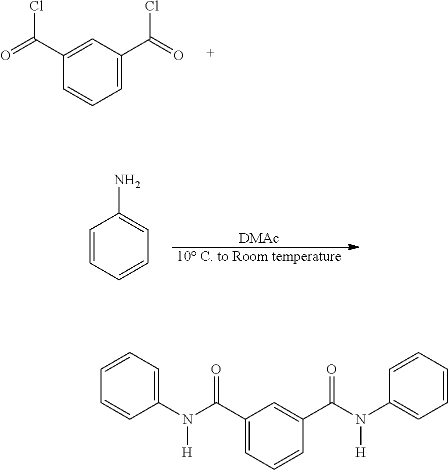

The experimental set up may consist of a 2 L glass beaker equipped with a glass rod stirrer coupled with an overhead mechanical stirrer. DMAc (1.5 L) may be added to the beaker and immersed in an ice bath to cool the solvent to 10-15° C. Then aniline (561.9 g) may be added to the solvent with constant stirring, the resultant mixture may be cooled to 10-15° C. Isophthaloyl chloride (350 g dissolved in 200 g of DMAc) may be added gradually to the cooled stirred mixture such that the temperature of the reaction was maintained below 30° C. The acid chloride was added over a period of one hour, after which the mixture was stirred for another three hours at 10-15° C. and then at room temperature overnight. The reaction mixture was milky white in appearance. The product was recovered by precipitation by addition of 1.5 L of distilled water and followed by was vacuum filtration using a filter paper and a Buchner funnel. The crude product was then washed with acetone (2 L) and then washed again with hot water (2 L). The product was then air dried over night at room temperature and then was dried in a vacuum oven 150° C. for 4-6 hours. The product (522 g) was a white solid. The melting point was 290° C. as determined by DSC.

### Synthesis of N1,N3,N5-triphenylbenzene-1,3,5-tricarboxamide Compound J

Compound J may be synthesized from trimesoyl chloride and aniline according to the following scheme:

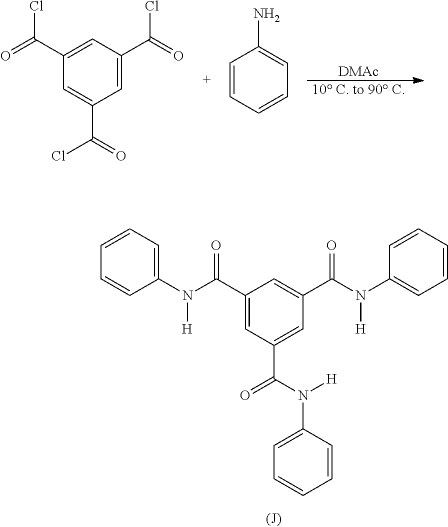

The experimental set up may consist of a 2 L glass beaker equipped with a glass rod stirrer coupled with an overhead mechanical stirrer. Trimesoyl chloride (200 g) may be dissolved in dimethyl acetamide (“DMAc”) (1 L) and cooled by an ice bath to 10-20° C. Aniline (421 g) may be added drop wise to a stirred solution of the acid chloride over a period of 1.5 to 2 hours. After the addition of the amine is completed, the reaction mixture may be stirred additionally for 45 minutes, after which the temperature is increased to 90° C. for about 1 hour. The mixture may be allowed to rest overnight at room temperature. The product may be recovered by precipitation through the addition of 1.5 L of distilled water, followed by vacuum filtration using a filter paper and a Buchner funnel. The crude product may be washed with acetone (2 L) and then washed again with hot water (2 L). The product may be air dried over night at room temperature and then dried in a vacuum oven 150° C. for 4 to 6 hours. The product (250 g) may be a white solid, and have a melting point of 319.6° C., as determined by differential scanning calorimetry (“DSC”).

### Synthesis of 1,3-Benzenedicarboxamide, N1,N3-dicyclohexyl Compound K1

The synthesis of Compound K1 from isophthaloyl chloride and cyclohexyl amine can be performed according to the following scheme:

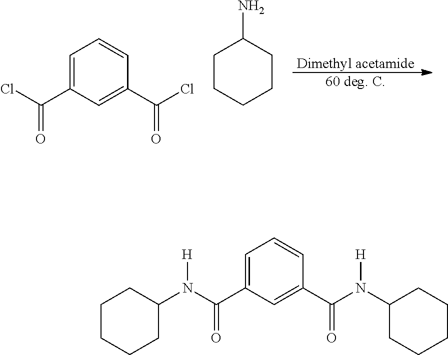

The experimental set up consisted of a 1 L glass beaker equipped with a glass rod stirrer coupled with an overhead mechanical stirrer. Cyclohexyl amine (306 g) was mixed in dimethyl acetamide (1 L) (alternatively N-methylpyrrolidone can also be used) and triethyl amine (250 g) at room temperature. Next isopthaloyl chloride (250 g) was slowly added over a period of 1.5 to 2 hours, to the amine solution with constant stirring. The rate of addition of the acid chloride was maintained such that the reaction temperature was maintained less than 60° C. After complete addition of the benzoyl chloride, the reaction mixture was gradually warmed to 85-90° C. and then allowed to cool to around 45-50° C. The mixture was allowed to rest overnight (for at least 3 hours) at room temperature. The product was recovered by precipitation through the addition of 1.5 L of distilled water, which was followed by was vacuum filtration using a filter paper and a Buchner funnel. The crude product was then washed with acetone (250 mL) and washed again with hot water (500 mL). The product (yield: ca. 90%) was then air dried over night at room temperature and then was dried in a vacuum oven 150° C. for 4 to 6 hours. The product was a white solid. The Proton NMR characterization was as follows: ¹H NMR (400 MHz d₆-DMSO): 8.3 (s, 2H, CONH), 8.22 (s, 1H, Ar), 7.9 (d, 2H, Ar), 7.5 (s, 1H, Ar), 3.7 (broad s, 2H, cyclohexyl), 1.95-1.74 broad s, 4H, cyclohexyl) and 1.34-1.14 (m, 6H, cyclohexyl).

### Example 1

A liquid crystalline polymer is formed according to the following process. Initially, a 300-liter Hastalloy C reactor was charged with 4-hydroxybenzoic acid (65.9 lbs.), 6-hydroxy-2-naphthoic acid (7.2 lbs.), terephthalic acid (2.8 lbs.), 4,4′-biphenol (18.8 lbs.), 4-hydroxyacetanilide (5.8 lbs.), and 3.4 g of potassium acetate. Compound A is also added in an amount so that it constitutes either 2.0 wt. % or 2.8 wt. % of the resulting polymer.

The reactor is equipped with a paddle-shaped mechanical stirrer, a thermocouple, a gas inlet, and distillation head. Under a slow nitrogen purge acetic anhydride (99.7% assay, 76.1 lbs.) is added. The milky-white slurry is agitated at 120 rpm and heated to 190° C. over the course of 130 minutes. During this time, approximately 42 pounds of acetic acid is distilled from the reactor. The mixture is then transferred to a 190 liter stainless steel polymerization reactor and heated at 1° C./min. to 245° C. At this point, a steady reflux of byproduct acetic acid is established, which reduces the heating rate to approximately 0.5° C./min. When the reaction mixture reaches 305° C., reflux is turned off and the batch is allowed to heat at a rate of about 1° C./min. During heating, the mixture grows yellow and slightly more viscous and the vapor temperature gradually drops below 100° C. as distillation of byproduct acetic acid comes to an end. Heating continues until the batch reaches the target temperature of 350° C. The nitrogen purge is stopped and a vacuum is applied to slowly reduce the pressure to less than 5 mm over a 45 minute period. As the time under vacuum progresses, the last traces of acetic acid are removed and the batch becomes more viscous. After 30 minutes under full vacuum (<5 mm), nitrogen is admitted to the system and the molten polymer is extruded from the reactor at 3 PSIG of pressure through a 3-hole die plate. The polymer strands are cooled and solidified by running through a water bath and then chopping into pellets.

The resulting polymer has a Tm of 325.6° C. and a melt viscosity of 5.0 Pa-s at a shear rate of 1000 sec⁻¹ as measured by capillary rheology at a temperature of 350° C.

### Example 2

Samples are formed by compounding various combinations of a liquid crystalline polymer, aluminum trihydrate (“ATH”), 4,4′-biphenol (“BP”), 2,6-naphthal dicarboxy acid (“NDA”), glass fibers, and talc. In Samples 2 and 4-6, the polymer of Example 1 is employed. In Sample 7, a polymer is employed that is formed in a manner similar to Example 1, except that Compound A is not added during formation but instead compounded with the other components as described below. Two comparative samples are also formed. More particularly, Sample 1 contains the polymer of Example 1 but lacks the addition of ATH/BP/NDA. Likewise, Sample 3 contains ATH/BP/NDA but lacks the addition of Compound A.

Regardless of their particularly constituents, the sample compositions are generally formed as followed. Pellets of the liquid crystalline polymer are dried at 150° C. overnight. Thereafter, the polymer and Glycolube™ P are blended and supplied to the feed throat of a ZSK-25 WLE co-rotating, fully intermeshing twin screw extruder in which the length of the screw is 750 millimeters, the diameter of the screw is 25 millimeters, and the L/D ratio is 30. The extruder has Temperature Zones 1-9, which may be set to the following temperatures: 330° C., 330° C., 310° C., 310° C., 310° C., 310° C., 320° C., 320° C., and 320° C., respectively. The screw design is selected so that melting begins at Zone 4. The polymer is supplied to the feed throat by means of a volumetric feeder. The glass fibers and talc are fed to Zone 4 and Zone 6, respectively. Once melt blended, the samples are extruded through a strand die, cooled through a water bath, and pelletized.

The characteristics of the samples are set forth below in Table 1.

TABLE 1
Sample Characteristics

| | L/D | L/D | | | | | | | |
|---|---|---|---|---|---|---|---|---|---|
| | After | Before | | | | | | Glass | |
| | Glass | Glass | LCP | Compound A | ATH | BP | NDA | Fibers | Talc |
| Sample | Fiber | Fiber | (wt. %) | (wt. %) | (wt. %) | (wt. %) | (wt. %) | (wt. %) | (wt. %) |
| 1 | 8.75 | 1.75 | 61.7 | 2.0 | — | — | — | 18 | 18 |
| 2 | 8.75 | 1.75 | 61.7 | 2.0 | 0.2 | 0.1 | 0.025 | 18 | 18 |
| 3 | 8.75 | 1.75 | 63.38 | — | 0.2 | 0.1 | 0.025 | 18 | 18 |
| 4 | 8.75 | 1.75 | 63.38 | 2.8 | 0.2 | 0.1 | 0.025 | 18 | 18 |
| 5 | 8.75 | 1.75 | 63.28 | 2.8 | 0.3 | 0.1 | 0.025 | 18 | 18 |
| 6 | 8.75 | 1.75 | 63.18 | 2.8 | 0.4 | 0.1 | 0.025 | 18 | 18 |
| 7 | 8.75 | 1.75 | 61.38 | 2.8 | 0.2 | 0.1 | 0.025 | 18 | 18 |

Parts are injection molded from Samples 1-7 and tested for their thermal and mechanical properties. The results are set forth below in Table 2.

TABLE 2
Sample Properties

| | Sample | | | | | | |
|---|---|---|---|---|---|---|---|
| | 1 | 2 | 3 | 4 | 5 | 6 | 7 |
| MV1000 (Pa-s) | 12.0 | 6.1 | 11.8 | 6 | 5 | 3 | 11 |
| MV400 (Pa-s) | 15.4 | 6.9 | 15.3 | 7 | 11 | 5 | 15 |
| Melt temp (° C.) | — | — | — | 322 | 319 | 319 | 334 |
| DTUL @ 1.8 | 243 | 239 | 239 | 242 | 238 | 235 | 241 |
| Mpa (° C.) | | | | | | | |
| Charpy Notched | 14.4 | 3.9 | 6.6 | 4.8 | 3.3 | 2.8 | 10.5 |
| (kJ/m2) | | | | | | | |
| Tensile strength | 110 | 108 | 110 | 107 | 96 | 87 | 116 |
| (MPa) | | | | | | | |
| Tensile modulus | 12230 | 12130 | 11109 | 12839 | 12717 | 12531 | 12543 |
| (MPa) | | | | | | | |
| Tensile | 1.6 | 1.7 | 2.3 | 1.5 | 1.1 | 1.0 | 2.3 |
| elongation (%) | | | | | | | |
| Flexural strength | 153 | 145 | 145 | 141 | 130 | 129 | 155 |
| (MPa) | | | | | | | |
| Flexural modulus | 12358 | 12291 | 11747 | 12416 | 12292 | 12186 | 12781 |
| (MPa) | | | | | | | |
| Flexural | 2.2 | 2.0 | 2.5 | 1.7 | 1.5 | 1.5 | 2.2 |
| elongation (%) | | | | | | | |
| Weldline | 7.8 | 7.6 | 8.3 | 7.0 | 6.4 | 6.4 | 8.3 |
| strength (lbf) | | | | | | | |
| Warpage before | 0.676 | 0.701 | 0.851 | 0.633 | 0.534 | 0.616 | 0.759 |
| reflow | | | | | | | |
| Warpage after | 2.772 | 2.650 | 2.688 | 2.272 | 2.509 | 2.397 | 2.961 |
| reflow | | | | | | | |
| LGA peak | 6356 | 4695 | 7154 | 4027 | 3790 | 3271 | 4722 |
| pressure (psi) | | | | | | | |

These and other modifications and variations of the present invention may be practiced by those of ordinary skill in the art, without departing from the spirit and scope of the present invention. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed is:

1. A thermoplastic composition that comprises a thermotropic liquid crystalline polymer, an aromatic amide oligomer, and a functional compound that includes hydroxyl groups, carboxyl groups, amine groups, or a combination thereof, wherein the thermoplastic composition has a melt viscosity of from about 0.1 to about 80 Pa-s, as determined at a shear rate of 1000 seconds⁻¹ and temperature of 350° C. in accordance with ASTM Test No. 1238-70.

2. The thermoplastic composition of claim 1, wherein the functional compound includes a hydroxy-functional compound having the general structure provided below in Formula (I): 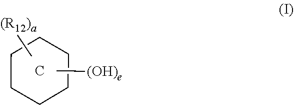
or a metal salt thereof, wherein,
ring C is a 6-membered aromatic ring wherein 1 to 3 ring carbon atoms are optionally replaced by nitrogen or oxygen, wherein each nitrogen is optionally oxidized, and wherein ring C may be optionally fused or linked to a 5- or 6-membered aryl, heteroaryl, cycloalkyl, or heterocyclyl;
R₁₂ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy;
a is from 0 to 4; and
e is from 1 to 3.

3. The thermoplastic composition of claim 2, wherein C is phenyl and e is 1 in Formula (I) such that the hydroxy-functional compound is a phenol.

4. The thermoplastic composition of claim 2, wherein C is phenyl, a is 1, and R₁₂ is phenyl in Formula (I) above such that the hydroxy-functional compound is a biphenyl compound having the following formula (III): 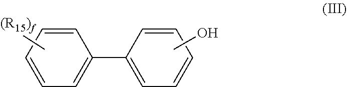
or a metal salt thereof, wherein,
R₁₅ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and
f is from 0 to 4.

5. The thermoplastic composition of claim 4, wherein the biphenyl compound is 4,4′-biphenol.

6. The thermoplastic composition of claim 2, wherein C is naphthenyl in Formula (I) above such that the hydroxy-functional compound is a naphthol compound.

7. The thermoplastic composition of claim 1, wherein the functional compound includes a metal hydroxide compound.

8. The thermoplastic composition of claim 7, wherein the metal hydroxide compound is copper (II) hydroxide (Cu(OH)₂), potassium hydroxide (KOH), sodium hydroxide (NaOH), magnesium hydroxide (Mg(OH)₂), calcium hydroxide (Ca(OH)₂), aluminum hydroxide (Al(OH)₃), or a combination thereof.

9. The thermoplastic composition of claim 1, wherein hydroxy-functional compounds constitute from about 0.05 wt. % to about 4 wt. % of the thermoplastic composition.

10. The thermoplastic composition of claim 1, wherein the thermoplastic composition includes a biphenyl hydroxy-functional compound and a metal hydroxide.

11. The thermoplastic composition of claim 10, wherein the weight ratio of metal hydroxides to biphenyl hydroxy-functional compounds is from about 0.5 to about 8.

12. The thermoplastic composition of claim 10, wherein biphenyl hydroxy-functional compounds constitute from about 0.01 wt. % to about 1 wt. % of the thermoplastic composition, and metal hydroxides constitute from about 0.02 wt. % to about 2 wt. % of the thermoplastic composition.

13. The thermoplastic composition of claim 1, wherein the functional compound includes a carboxy-functional compound having the general structure provided below in Formula (V): 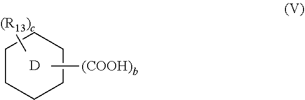
or a metal salt thereof, wherein,
ring D is a 6-membered aromatic ring wherein 1 to 3 ring carbon atoms are optionally replaced by nitrogen or oxygen, wherein each nitrogen is optionally oxidized, and wherein ring D may be optionally fused or linked to a 5- or 6-membered aryl, heteroaryl, cycloalkyl, or heterocyclyl;
R₁₃ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy;
b is from 1 to 3; and
c is from 0 to 4.

14. The thermoplastic composition of claim 13, wherein D is phenyl and b is 1 in Formula (V) such that the hydroxy-functional compound is a phenolic acid compound.

15. The thermoplastic composition of claim 13, wherein D is phenyl, c is 1, and R₁₃ is phenyl in Formula (V) above such that the carboxy-functional compound is a diphenolic acid compound having the following formula (VII): 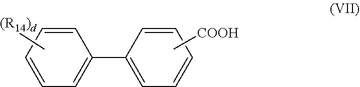
or a metal salt thereof, wherein,
R₁₄ is acyl, acyloxy, acylamino, alkoxy, alkenyl, alkyl, amino, aryl, aryloxy, carboxyl, carboxyl ester, cycloalkyl, cycloalkyloxy, hydroxyl, halo, haloalkyl, heteroaryl, heteroaryloxy, heterocyclyl, or heterocycyloxy; and
d is from 0 to 4.

16. The thermoplastic composition of claim 13, wherein D is naphthenyl in Formula (V) above such that the hydroxy-functional compound is a naphthenic acid compound.

17. The thermoplastic composition of claim 16, wherein the naphthenic acid compound is 2,6-napthalene dicarboxylic acid.

18. The thermoplastic composition of claim 1, wherein carboxy-functional compounds constitute from about 0.001 wt. % to about 0.5 wt. % of the thermoplastic composition.

19. The thermoplastic composition of claim 1, wherein the thermoplastic composition contains at least one hydroxy-functional compound and at least one carboxy-functional compound, and wherein the weight ratio of hydroxy-functional compounds to carboxy-functional compounds is from about 5 to about 20.

20. The thermoplastic composition of claim 1, wherein the aromatic amide oligomer is employed in an amount of from about 0.1 to about 5 parts by weight relative to 100 parts by weight of the liquid crystalline polymer.

21. The thermoplastic composition of claim 1, wherein the aromatic amide oligomer has a molecular weight of from about 100 to about 1,500 grams per mole.

22. The thermoplastic composition of claim 1, wherein the oligomer has from 2 to 8 amide bonds per molecule.

23. The thermoplastic composition of claim 1, wherein the oligomer has the following general formula (IX): 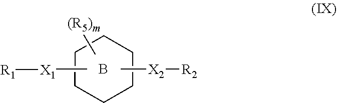
wherein,
ring B is a 6-membered aromatic ring wherein 1 to 3 ring carbon atoms are optionally replaced by nitrogen or oxygen, wherein each nitrogen is optionally oxidized, and wherein ring B may be optionally fused or linked to a 5- or 6-membered aryl, heteroaryl, cycloalkyl, or heterocyclyl;
R₅ is halo, haloalkyl, alkyl, alkenyl, aryl, heteroaryl, cycloalkyl, or heterocyclyl;
m is from 0 to 4;
X₁ and X₂ are independently C(O)HN or NHC(O); and
R₁ and R₂ are independently selected from aryl, heteroaryl, cycloalkyl, and heterocyclyl.

24. The thermoplastic composition of claim 23, wherein ring B is phenyl.

25. The thermoplastic composition of claim 1, wherein the oligomer is selected from the group consisting of the following compounds:

| Structure | Name |
|---|---|
| 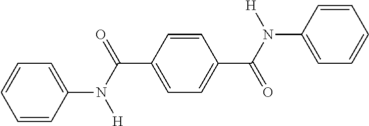 [SMILES: O=C(Nc1ccccc1)c1ccc(C(=O)Nc2ccccc2)cc1] | N1,N4-diphenylterephthalamide |
| 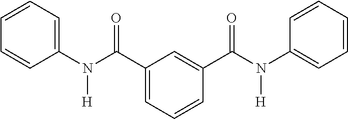 [SMILES: O=C(Nc1ccccc1)c1cccc(C(=O)Nc2ccccc2)c1] | N1,N4-diphenylisoterephthalamide |
| 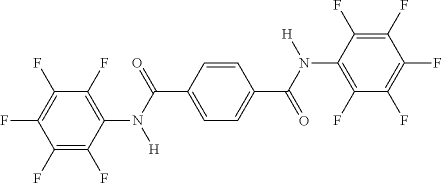 [SMILES: O=C(Nc1c(F)c(F)c(F)c(F)c1F)c1ccc(C(=O)Nc2c(F)c(F)c(F)c(F)c2F)cc1] | N1,N4-bis(2,3,4,5,6- pentafluorophenyl)terephthalamide |
| 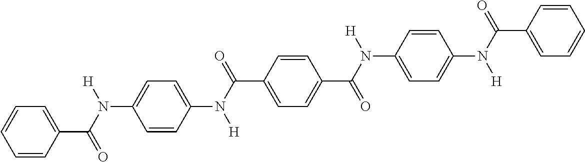 [SMILES: O=C(Nc1ccc(NC(=O)c2ccc(C(=O)Nc3ccc(NC(=O)c4ccccc4)cc3)cc2)cc1)c1ccccc1] | N1,N4-bis(4- benzamidophenyl)terephthalamide |
| 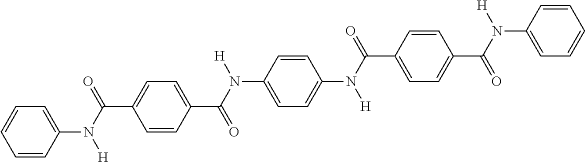 [SMILES: O=C(Nc1ccccc1)c1ccc(C(=O)Nc2ccc(NC(=O)c3ccc(C(=O)Nc4ccccc4)cc3)cc2)cc1] | N4-phenyl-N1-[4-[[4- (phenylcarbamoyl)benzoyl] amino]phenyl] terephthalamide |
| 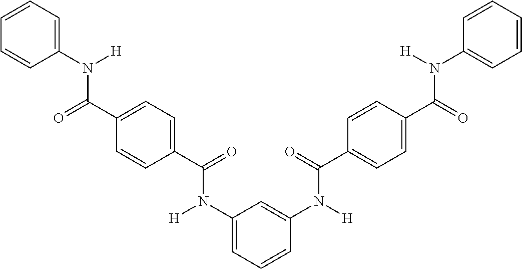 [SMILES: O=C(Nc1ccccc1)c1ccc(C(=O)Nc2cccc(NC(=O)c3ccc(C(=O)Nc4ccccc4)cc3)c2)cc1] | N4-phenyl-N1-[3-[[4- (phenylcarbamoyl)benzoyl] amino]phenyl] terephthalamide |
| 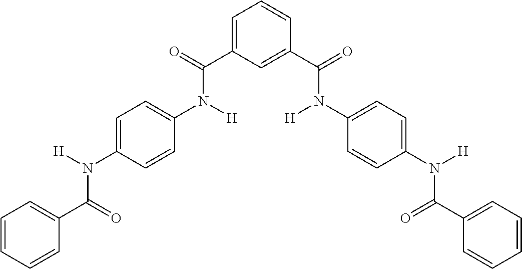 [SMILES: O=C(Nc1ccc(NC(=O)c2cccc(C(=O)Nc3ccc(NC(=O)c4ccccc4)cc3)c2)cc1)c1ccccc1] | N1,N3-bis(4-benzamidophenyl) benzene- 1,3-dicarboxamide |
| 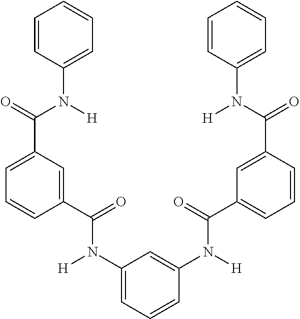 [SMILES: O=C(Nc1ccccc1)c1cccc(C(=O)Nc2cccc(NC(=O)c3cccc(C(=O)Nc4ccccc4)c3)c2)c1] | N3-phenyl-N1-[3-[[3- (phenylcarbamoyl)benzoyl] amino]phenyl] benzene-1,3-dicarboxamide |
| 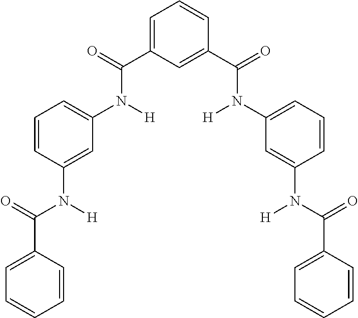 [SMILES: O=C(Nc1cccc(NC(=O)c2cccc(C(=O)Nc3cccc(NC(=O)c4ccccc4)c3)c2)c1)c1ccccc1] | N1,N3-bis(3-benzamidophenyl) benzene- 1,3-dicarboxamide |
| 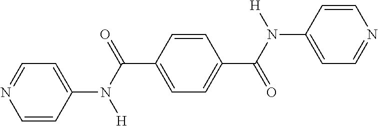 [SMILES: O=C(Nc1ccncc1)c1ccc(C(=O)Nc2ccncc2)cc1] | N1,N4-bis(4-pyridyl) terephthalamide |
| 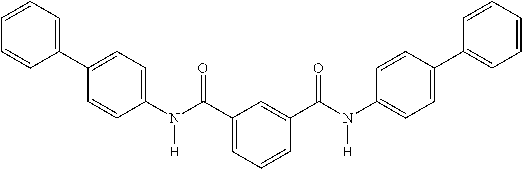 [SMILES: O=C(Nc1ccc(-c2ccccc2)cc1)c1cccc(C(=O)Nc2ccc(-c3ccccc3)cc2)c1] | N1,N3-bis(4-phenylphenyl) benzene-1,3- dicarboxamide |
| 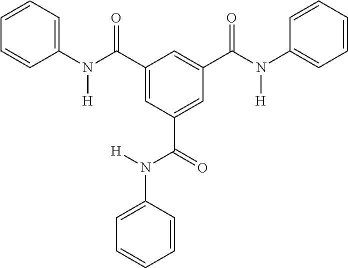 [SMILES: O=C(Nc1ccccc1)c1cc(C(=O)Nc2ccccc2)cc(C(=O)Nc2ccccc2)c1] | N1,N3,N5-triphenylbenzene- 1,3,5-tricarboxamide |
| 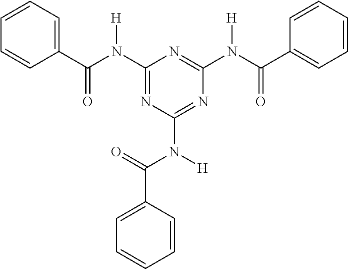 [SMILES: O=C(Nc1nc(NC(=O)c2ccccc2)nc(NC(=O)c2ccccc2)n1)c1ccccc1] | N-(4,6-dibenzamido-1 ,3,5-triazin- 2-yl)benzamide |
| 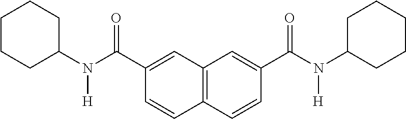 [SMILES: O=C(NC1CCCCC1)c1ccc2ccc(C(=O)NC3CCCCC3)cc2c1] | N2,N7-dicyclohexylnaphthalene- 2,7-dicarboxamide |
| 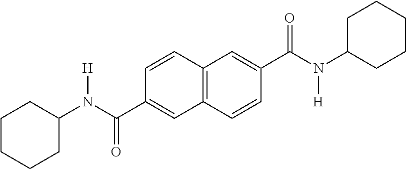 [SMILES: O=C(NC1CCCCC1)c1ccc2cc(C(=O)NC3CCCCC3)ccc2c1] | N2,N6-dicyclohexylnaphthalene- 2,6-dicarboxamide |
| 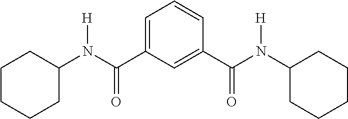 [SMILES: O=C(NC1CCCCC1)c1cccc(C(=O)NC2CCCCC2)c1] | 1,3-Benzenedicarboxamide, N1,N3-dicyclohexyl |
| 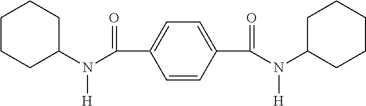 [SMILES: O=C(NC1CCCCC1)c1ccc(C(=O)NC2CCCCC2)cc1] | 1,4-Benzenedicarboxamide, N1,N3-dicyclohexyl. |

26. The thermoplastic composition of claim 1, wherein the aromatic amide oligomer is N1,N4-diphenylterephthalamide.

27. The thermoplastic composition of claim 1, wherein the polymer contains monomer units derived from 4-hydroxybenzoic acid, terephthalic acid, isophthalic acid, hydroquinone, 4,4′-biphenol, acetaminophen, 6-hydroxy-2-naphthoic acid, or a combination thereof.

28. The thermoplastic composition of claim 1, wherein the composition has a melt viscosity of from about 1 to about 25 Pa-s, as determined at a shear rate of 1000 seconds⁻¹ and temperature of 350° C. in accordance with ASTM Test No. 1238-70.

29. The thermoplastic composition of claim 1, wherein the composition further comprises fibers having a volume average length of from about 50 to about 400 micrometers.

30. A molded part comprising the thermoplastic composition of claim 1.

31. The molded part of claim 30, wherein the part has at least one dimension of about 500 micrometers or less.

32. An electrical connector that comprises opposing walls between which a passageway is defined for receiving a contact pin, wherein at least one of the walls contains the molded part of claim 30.

33. The molded part of claim 30, wherein one or more conductive elements are applied to the part.

34. The molded part of claim 33, wherein the conductive elements are resonating antenna elements, inverted-F antenna structures, closed and open slot antenna structures, loop antenna structures, monopoles, dipoles, planar inverted-F antenna structures, or a combination thereof.

35. A handheld device that comprises an antenna structure, wherein the antenna structure comprises the molded part of claim 30.

36. An integrated circuit comprising the molded part of claim 30.

37. An electronic component that comprises the molded part of claim 30.

38. The electronic component of claim 37, wherein the electronic component is a cellular telephone, laptop computer, small portable computer, wrist-watch device, pendant device, headphone or earpiece device, media player with wireless communications capabilities, handheld computer, remote controller, global positioning system, handheld gaming device, battery cover, speaker, integrated circuit, electrical connector, camera module, or a combination thereof.

39. The electronic component of claim 38, wherein the electronic component is an electrical connector.

40. The electronic component of claim 38, wherein the electronic component is a camera module.

41. The electronic component of claim 38, wherein the electronic component is a cellular telephone.

42. A method for forming a thermoplastic composition within an extruder, the extruder containing at least one rotatable screw within a barrel, wherein the screw has a total length and diameter and wherein a feed section and melt section located downstream from the feed section are defined along the length of the screw, the method comprising:
supplying a base polymer composition to the feed section of the extruder that contains a thermotropic liquid crystalline polymer and an aromatic amide oligomer;
supplying fibers to the extruder at a location downstream from the base polymer composition;
supplying a functional compound that includes a hydroxy-functional compound, carboxy-functional compound, or a combination thereof, to the extruder at a location downstream from the base polymer composition; and
blending the functional compound, fibers, and the base polymer composition within the extruder to form the thermoplastic composition.

43. The method of claim 42, wherein the functional compound is supplied at a location downstream from the fibers.

44. A method for forming a thermoplastic composition within an extruder, the extruder containing at least one rotatable screw within a barrel, wherein the screw has a total length and diameter and wherein a feed section and melt section located downstream from the feed section are defined along the length of the screw, the method comprising:
supplying a base polymer composition to the feed section of the extruder that contains a thermotropic liquid crystalline polymer;
supplying fibers to the extruder at a location downstream from the base polymer composition;
supplying an aromatic amide oligomer and a functional compound that includes a hydroxy-functional compound, carboxy-functional compound, or a combination thereof, to the extruder at a location downstream from the base polymer composition; and
blending the aromatic amide oligomer, functional compound, fibers, and the liquid crystalline polymer within the extruder to form the thermoplastic composition.

45. The method of claim 44, wherein the aromatic amide oligomer and the functional compound are supplied at a location downstream from the fibers.
